(19) United States
(12) Patent Application Publication
(10) Pub. No.: US 2007/0038867 A1
(43) Pub. Date: Feb. 15, 2007

(54) System for biometric signal processing with hardware and software acceleration

(76) Inventors: Ingrid M. Verbauwhede, Palo Alto, CA (US); Patrick R. Schaumont, Blacksburg, VA (US); David D. Hwang, Irvine, CA (US); Bo-Cheng Lai, Los Angeles, CA (US); Shenglin Yang, Boise, ID (US); Kazuo Sakiyama, Leuven-Heverlee (BE); Yi Fan, Valencia, CA (US); Alireza Hodjat, Santa Monica, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/554,763

(22) PCT Filed: Jun. 2, 2004
(86) PCT No.: PCT/US04/17545

§ 371 Date: Aug. 7, 2006

Related U.S. Application Data
(60) Provisional application No. 60/475,242, filed on Jun. 2, 2003.

(51) Int. Cl. H04K 1/00

(52) U.S. Cl. 713/186

(57) ABSTRACT

A secure embedded system that uses cryptographic and biometric signal processing acceleration is described. In one embodiment, the secure embedded system is configured as a wireless pay-point protocol for brick-and-mortar and e-commerce applications in which biometric information is localized and does not require transmission of biometric data for authentication. In one embodiment, a key-generation function uses a dynamic key generator and static biometric components. In one embodiment, an embedded system design methodology provides hardware and software acceleration transparency.

### REFERENCE TO RELATED APPLICATION

The present application claims priority benefit if U.S. Provisional Application No. 60/475,242, filed Jun. 2, 2003, titled “SYSTEM FOR BIOMETRIC SIGNAL PROCESSING WITH HARDWARE AND SOFTWARE ACCELERATION,” the entire contents of which is hereby incorporated by reference.

### GOVERNMENT INTEREST STATEMENT

Portions of the subject matter of this application were invented under a contract with an agency of the United States Government, under NSF contract No. 0098361.

### BACKGROUND

1. Field of the Invention

The present invention relates to systems using biometric signal processing for authentication in connection with a secure communication protocol.

2. Description of the Related Art

In February 2003, a computer hacker breached the security systems of Visa and MasterCard and accessed 5.6 million valid account numbers, which represents approximately 1% of all 574 million valid account numbers in the United States. Though the accounts were not used fraudulently, a burdensome recall and replacement of valid cards throughout many financial institutions was required. On the Internet, a number of black-market sites sell active credit card account numbers and expiration dates for a modest price. In brick-and-mortar credit card scenarios, photograph identification or signatures are inconsistently checked in normal purchases; hence, fraudulent transactions are commonplace. These situations are just a few which expose the current flaw in traditional transaction protocols, which is mainly a flaw in authentication. Identity theft results in losses of well over a billion dollars a year for credit card issuers, and is even more widespread since the advent of e-commerce on the Internet. The primary reason for the continued success of identity theft is the lack of the ability to prove that an account is used by the genuine, authorized, consumer.

### SUMMARY

The present invention solves these and other problems by providing a secure embedded system that uses cryptographic and biometric signal processing to provide identity authentication. In one embodiment, the secure embedded system is configured as a wireless pay-point device, called a thumbpod, for brick-and-mortar and/or e-commerce applications. In one embodiment, the thumbpod localizes a sensitive biometric template and does not require transmission of biometric data for authentication. In one embodiment, a key-generation function uses a dynamic key generator and static biometric components. An embedded system design methodology known as hardware/software acceleration transparency is provided to improve performance of the thumbpod. In one embodiment, acceleration transparency is provided in a systematic method to accelerate Java functions in both software and hardware of, for example, an encryption function.

In one embodiment, the thumbpod is designed as a secure embedded device that provides a protocol for wireless pay-point transactions in a secure manner. The protocol uses secure cryptographic primitives as well as biometric authentication techniques. The security protocol used in the thumbpod is based on a protocol that uses the thumbpod as an interface between an authentication server and a user.

In one embodiment, the thumbpod includes a microcontroller, a fingerprint image sensor, signal processing hardware acceleration, cryptographic hardware acceleration, and a memory module enclosed within a form factor similar to an automobile keychain transmitter. The thumbpod provides flexible communication via ports, such as, for example, a port for wireless communication and/or a wired port for fast wire-line communication. The wireless port can be, for example, an infrared port, a radio-frequency port, an inductive coupling port, a capacitive coupling port, a Bluetooth port, a wireless Ethernet port, etc. The wired port can be, for example, a USB port, a firewire port, a serial port, an Ethernet port, etc. The thumbpod can be used for a wide variety of authentication-related transactions, such as, for example, wireless credit card payments, keychain flash memory replacement, universal key functionality (house, car, office), storage of sensitive medical data, IR secure printing, etc.

In one embodiment, a security protocol binds the user to the device through biometrics, combines biometrics and traditional security protocols, protects biometric data by keeping at least a portion of the biometric data in a protected form that does not leave the device, and provides that biometric calculations are provided on the device. In one embodiment, biometric algorithms are provided to fit a relatively constrained environment of embedded devices. In one embodiment, algorithms are provided in fixed point arithmetic. In one embodiment, memory storage optimization and hardware acceleration are provided by converting a least a portion of one or more software algorithms into hardware.

### BRIEF DESCRIPTION OF THE DRAWINGS

The various features of the present are described with reference to the following figures.

FIG. 1 shows layers of an embedded security protocol system.

FIG. 2 shows one embodiment of a thumbpod device.

FIG. 3A is a block diagram of an authentication protocol having a relatively strong one-way authentication protocol between the server and the device and a relatively week security protocol between and the device and the user.

FIG. 3B is a block diagram of an authentication protocol having a relatively strong two-way authentication protocol between the server and the device and a relatively strong security protocol between and the device and the user.

FIG. 4 is a further block diagram of one embodiment of the authentication protocol shown in FIG. 3B.

FIG. 5 shows authentication protocol vector generation in the authentication server.

FIG. 6 shows authentication vector generation in the thumbpod device of FIG. 2.

FIG. 7 shows generation of authentication functions F1-F5.

FIG. 8 is a block diagram of the Rijndael CBC-MAC algorithm.

FIG. 9 is a block diagram of the Rijndael OFB-Counter algorithm.

FIG. 10 is a block diagram of the NIST minutia extraction flow algorithm the fingerprint identification system.

FIG. 11 shows window rotation in the fingerprint identification system.

FIG. 12 shows an example of an original image in the fingerprint identification system.

FIG. 13 shows minutiae points in the image of FIG. 12 after binarization.

FIG. 14 shows matching flow in the fingerprint identification system.

FIG. 15 shows local features of fingerprint minutia.

FIG. 16 is a chart showing the execution time for various operations in the minutia detection algorithm at the block diagram level.

FIG. 17 is a chart showing the execution time for various operations in the minutia detection algorithm at the instruction level.

FIG. 18 shows an example of the direction map.

FIG. 19 shows the relationships between execution time, error rate, and ETH in the fingerprint identification system.

FIG. 20 is a block diagram of a memory-mapped EFT accelerator.

FIG. 21 is a chart showing execution time for different embodiments of the fingerprint identification system.

FIG. 22 is a chart showing energy consumption for different embodiments of the fingerprint identification system.

FIG. 23 shows profiling results for the baseline algorithm in the fingerprint identification system.

FIG. 24 shows relationships between the pre-checking threshold and performance of the fingerprint identification system.

FIG. 25A is a chart comparing the execution time for the baseline and the optimized fingerprint matching systems.

FIG. 25B is a chart comparing the energy consumption for the baseline and the optimized fingerprint matching systems.

FIGS. 26A-26F show various embodiments of hardware or software acceleration transparency.

FIG. 27 shows acceleration of the Rijndael algorithm using hardware and software acceleration.

FIG. 28A is a block diagram showing a functional model of hardware/software accelerator design.

FIG. 28B is a block diagram showing a benchmarking functional model of hardware/software accelerator design.

FIG. 28C is a block diagram showing a transaction-level model of hardware/software accelerator design.

FIG. 28D is a block diagram showing an embedded software implementation model functional model of hardware/software accelerator design for a personal computer implementation.

FIG. 28E is a block diagram showing an embedded software implementation model of software accelerator design for a board-level implementation.

FIG. 28F is a block diagram showing an embedded software implementation model of hardware/software accelerator design for a board-level implementation.

FIGS. 29(a) and (b) shows one embodiment of a software acceleration architecture.

### DETAILED DESCRIPTION

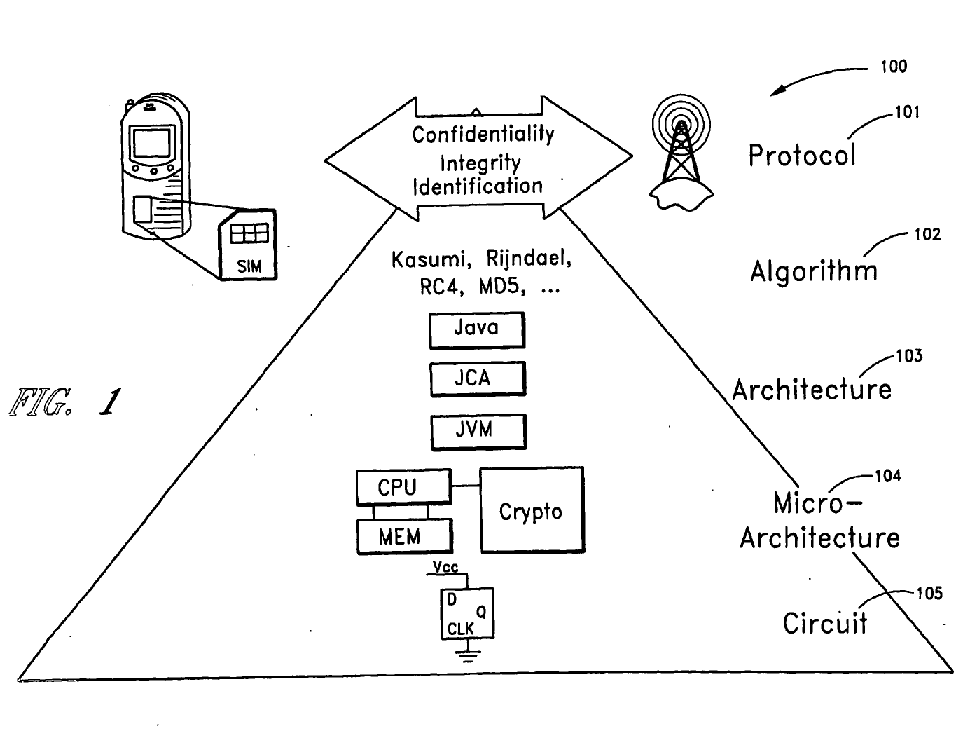

FIG. 1 shows layers of an embedded security protocol system 100. At the highest level, the system 100 includes a protocol layer 101 that provides confidentiality and identify verification. An algorithm layer 102 is provided below the protocol layer 101. The algorithm layer 101 includes one or more algorithms, such as, for example, encryption algorithms (e.g., Kasumi, Rijndael, RC4, MD5, etc.), used by the protocol layer 101. In the present disclosure, the Rijndael algorithm is used by way of example of an encryption algorithm, and not by way of limitation. An architecture layer 103 is provided below the algorithm layer 102. In one embodiment, the architecture layer 103 includes a virtual machine, such as, for example, a JAVA virtual machine. A micro-architecture layer 104 is provided below the architecture layer 103. In one embodiment, the micro-architecture layer 104 includes one or more processor architectures. A circuit layer 105 is provided below the micro-architecture layer 104.

As security is only as strong as the weakest link, a breech in any of the abstraction layers 101-105 can compromise the entire security model. Hence design of the secure embedded system is based on a top-down design flow and security scrutiny at each abstraction level.

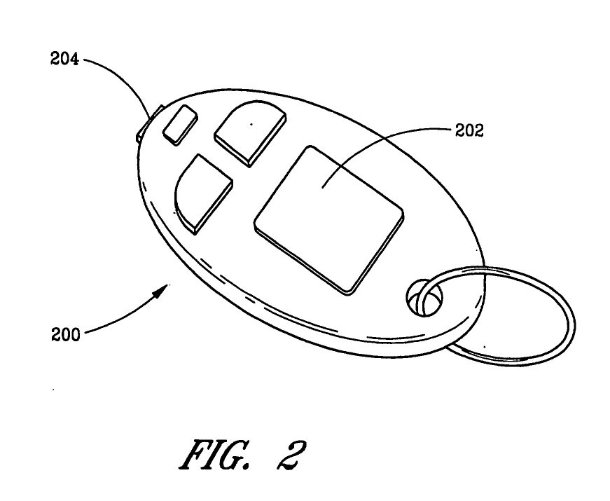

FIG. 2 shows a thumbpod 200 as an embodiment of a device that is based on the security pyramid shown in FIG. 1. The thumbpod 200, is configured as a keychain-type device that includes a biometric sensor 202, a communication port 204, and embedded hardware components. The sensor 202 obtains biometric identification data (e.g., fingerprint identification data, voice identification data, retina identification data, genetic identification data, etc.) from a user. In an alternative embodiment, the thumbpod 200 includes a sensor 202 for obtaining identification data from a user, such as, for example, biometric identification data, password data, PIN data, Radio Frequency Identification Tag (RFD) data, etc. In one embodiment, the sensor 202 is a fingerprint sensor. In one embodiment, the sensor is an imaging device. In one embodiment, the sensor 202 includes a CMOS imaging device. A fingerprint device is used herein by way of example, and not by way of limitation.

The communication port 204 can include a wireless port and/or a wired port to provide flexible communication. In one embodiment, the port 204 includes a wireless port, such as, for example, an infrared port, a radio-frequency port, an inductive coupling port, a capacitive coupling port, a Bluetooth port, a wireless Ethernet port, etc. In one embodiment, the port 204 includes a wired port, such as, for example, a USB port, a firewire port, a serial port, an Ethernet port, a PCMCIA port, a flash memory port, etc.

The thumbpod 200 is configured to be used in connection with a security protocol (as described in connection with FIGS. 3 and 4 to provide safe use of biometric sensor data. The biometric data does not leave the thumbpod 200 but it is used with a split-key generation function to protect the data. The thumbpod 200 provides a verifiable bond between a user and the thumbpod 200 based on biometric sensor data. The thumbpod can be used for a wide variety of authentication-related transactions, such as, for example, wireless credit card payments, keychain flash memory replacement, universal key functionality (house, car, office), storage of sensitive medical data, IR secure printing, etc.

The thumbpod 200 uses biometrics to bind a user to an identification code, such as, for example, an account number, an access code, a password, an the like (hereinafter referred to generically as an account number). At each transaction, the user's biometric data (e.g., fingerprint) is used to digitally sign a transaction as proof of identification. This fingerprint is digitally verified by an authentication server. The protocol used by the thumbpod and the authentication server ensure that sensitive biometric data is not transmitted freely, particularly across wireless or other insecure channels. The protocol described below provides an authentication scheme in which no actual biometric data is transmitted and no biometric data is stored at the server. Rather, biometric information is captured in the thumbpod 200 and used to generate a key K (which is stored at the authentication server) for symmetric-key encryption. This key is used to encrypt challenge and response functions, based on a random number, which are in turn transmitted across the wireless channel.

FIG. 3A is a block diagram of an authentication protocol 300 that uses a relatively strong one-way authentication protocol between an authentication server 310 and an authentication device 311, and a relatively week security protocol between and the device 311 and a user 303, as is currently used in traditional credit card authorization systems. In the traditional credit card authentication scheme, a server authenticates merely with a physical credit card (or more specifically, with an account number stored on a magnetic strip of a credit card). In an e-commerce scenario, a physical card is not required—an account number and expiration date are sufficient. The traditional schemes provide a two-fold authentication: 1) the server authenticates the credit device, and 2) the server (nominally) authenticates the ownership of the card. A significant problem with the current credit card-type transaction protocols is the weak authentication tie between the user and the transaction device (the credit card). It is often the case that in brick-and-mortar commerce, proof of authentication is not required. In ATM transactions, a personal identification number (PIN) may tie a user to the card. However, PIN numbers do not provide high levels of security. PIN number are often easily broken or repetitive numbers, written on the back of cards, forgotten, etc.

FIG. 3B is a high-level block diagram of an authentication protocol 301 used in connection with the thumbpod 200. The authentication protocol 301 uses a relatively strong two-way authentication protocol between the authentication server 310 and the authentication device (e.g., the thumbpod 200), and a relatively strong authentication protocol (e.g., biometric authentication) between and the thumbpod 200 and the user 303.

The protocol 301 is an example of a complex application in which thumbpod 200 uses both cryptographic and signal processing functionality. There are various other protocols for other applications for the thumbpod 200 that share one or both of the common denominators of cryptography and biometric signal processing. Other applications include encryption/decryption and/or verification for audio and video systems.

FIG. 4 shows an example system 400 that uses the authentication protocol 301 and a flow diagram of the authentication protocol 301. The system 400 includes the thumbpod 200, a merchant's transaction register 401, and the authentication server 310. The authentication protocol 301 can be used in connection with a brick-and-mortar pay-point transaction, an e-commerce transaction, a computer login transaction, or any other transaction the requires authentication.

In the protocol 301, the thumbpod 200 sends an account number to the transaction register 401. The transaction register 401 then sends the account number and data regarding the transaction (e.g., a transaction dollar amount), to the server 310. The transaction register 401 and the server 310 provide mutual authentication through standard protocols, such as, for example, the SET protocol. The server 310 uses the account number to look up the identity of the thumbpod 200 and to obtain a secret key known to the thumbpod 200. The server 310 generates a first authentication vector and encrypts the first authentication vector using the secret key. The encrypted first authentication vector is then sent to the transaction register 401. The transaction register forwards the first authentication vector to the thumbpod 200. The thumbpod 200 decrypts the first authentication vector and verifies the identity of the authentication server 310. The thumbpod also authenticates the user and generates a second authentication vector. The second authentication vector is encrypted using the secret key. The thumbpod 200 returns the authentication vector to the transaction register 401, which forwards the second authentication vector to the authentication server 310. The authentication server 310 decrypts the second authentication vector and verifies the identity of the thumbpod 200. Once the identity of the thumbpod has been verified, the authentication server 310 sends a “transaction complete” message to the transaction register 401. The transaction forwards the transaction complete message to the thumbpod 200, which then increments a transaction counter. In one embodiment, streaming encryption is provided between the thumbpod 200, the transaction register 401, and/or the server 310.

In order to make a transaction at the transaction register 401, the user 303 uses the thumbpod wireless port 204 to initiate communication with the register. Challenge and response functions are negotiated between the user 303 and the server 310, routed through the merchant's register 410 (which cannot interpret the data because it does not posses secret keys known to the thumbpod 200 and the server 310). In the course of the authentication protocol, the user 303 places his/her finger on the fingerprint sensor 202 to provide identity verification. This information is processed within the thumbpod 200 and, if a match is made, cryptographic hash functions and keys are generated using encryption algorithms and the protocol continues to its completion.

In the protocol 301, three items are used for valid authentication transactions: 1) the account number stored in the thumbpod 200, 2) the thumbpod 200 itself (which generates the secret key K), and 3) the correct biometric component (e.g., a finger, a retina, etc.) for live-scan sensing by the sensor 202. These three elements provide a strong tie between the user 310 and the thumbpod 200 account number. In an e-commerce situation, merely having a stolen account number (and expiration date) would be insufficient to make a transaction. Likewise, an account number and a stolen thumbpod 200 are also insufficient. All three components are required to make a valid transaction.

In the protocol 301 a threefold-authentication takes place: 1) the server 310 authenticates the thumbpod 200, 2) the thumbpod 200 authenticates the server 310 (and transaction register 410), and 3) the thumbpod 200 authenticates the user 310. Unlike traditional schemes, the user 303 authenticates the server and the transaction register 401, providing protection against fraudulent or malicious merchants. Hence, the protocol retains the advantages of the current credit card-type protocols, while supplementing the protocols with stronger security, transaction device-to-user binding, and authentication directionality. Other advantages of the protocol 301 include fraud detection as well as authentication at each transaction.

As shown in FIG. 4, the thumbpod 200 begins the transaction by transmitting the user's account identification to the merchant's transaction register 401. The transaction register 401 authenticates with the authentication server using conventional protocols. Note that the protocol 301 need not replace current protocols. Rather, the protocol 301 supplements the current protocols with an additional layer of encryption-based authentication. The transaction register 401 transmits the account number and the transaction amount to the authentication server 310.

The server 310 begins its side of the authentication process by loading the user's secret key K, which is shared only between the server 310 and the thumbpod 200. In one embodiment, the secret key is at least 128 bits. The server 310 also loads a user's counter value SQN_{AS} and an institution authentication parameter AMF. In one embodiment, the counter value SQN_{AS} is at least 48 bits, and the institution authentication parameter AMF is at least a 16 bits. The counter value SQN_{AS} is stored both on the server and on the thumbpod 200 and is used to prevent replay attacks. The server 310 loads and encrypts an operator code OP, producing OP_{C} (which can be optionally pre-stored). In one embodiment, the operator code OP is at least 128 bits. Finally, the server 310 generates a random value RAND and uses K with Rijndael primitives to generate a set of authentication parameters for the specific transaction. In one embodiment, RAND is at least 128 bits. The authentication parameters include:
MAC_{AS}: a message authentication code of the server to prove its identity to the thumbpod 200 (in one embodiment, the MAC_{AS} is at least 64-bits).
XRES_{AS}: an expected response of the thumbpod 200 to prove its identity to the server (in one embodiment, XRES_{AS} is at least 64 bits).
AK: an anonymity key to mask the counter value CTR_{AS} for transmission (in one embodiment, AK is at least 48 bits).
CK (optional): a cipher key to allow for streaming encryption after authentication is performed (in one embodiment, CK is at least 128 bits).
IK(optional): an integrity key allowing for data integrity and origin authentication of streaming encryption data (in one embodiment, IK is at least 128 bits).

After the above authentication parameters are generated, the server 310 transmits a subset of the authentication parameters—the authentication vector—to the transaction register, which forwards the vector to the Thumbpod 200. The authentication vector includes:
RAND;
SQN_{AS}: the counter value of the server masked by the anonymity key;
AMF: the institution authentication parameter; and
MAC_{AS}: the message authentication code of the server to prove its identity to the thumbpod 200.

J As in 3GPP authentication, the authentication between the thumbpod 200 and the server 310 is a mutual authentication based on the shared secret key K. The random session value RAND is coupled with K to provide the two primary challenge/response vectors: MAC_{AS} and RES_{TP}. The MAC_{AS} vector proves the identity of the server 310 to the thumbpod 200. Only the server 310 with the precise value of K (and the current random session value RAND) will be able to produce the proper MAC_{AS}. When the thumbpod 200 verifies this value by comparison with its generated expected value of XMAC_{TP} (based on K and RAND) it determines whether the proper key K was used, and hence whether the server 310 is genuine. The same argument holds for the RES_{TP} vector, which is used to verify the identity of the thumbpod 200 to the server by comparison with XRES_{AS}. When both challenge/response values are verified, then mutual authentication is assured. The random number RAND and the sequence number SQN_{TP/AS} are used to prevent replay attacks on previously-used authentication vectors obtained through eavesdropping on the channel. Since the sequence number follows a deterministic pattern (bit increment at each transaction), it is masked by a one-use anonymity key AK as it is transmitted over the channel to prevent smart replay attacks.

At this point, the protocol 301 enters into a biometric authentication portion which differs from 3GPP or other wireless authentication protocols. The thumbpod 200 stores the authentication vector and begins biometric authentication by requesting that the user 303 to provide biometric data (e.g., place his/her finger on the fingerprint sensor 202). The Thumbpod 200 performs imaging, feature extraction, matching, and decision. During imaging, the thumbpod 200 images fingerprint to produce a bitmap of raw data. In one embodiment, the bitmap is at least 128×128 8-bit grayscale. During feature extraction, the thumbpod 200 processes the raw data, enhances the image, and extracts the minutiae types (ridges, bifurcations) and locations of the candidate fingerprint. During the matching process, the thumbpod 200 loads a stored fingerprint template and performs a matching function to produce a match score. During the decision process, the thumbpod 200, using the match score, decides if the candidate fingerprint is a match to the template.

If the algorithm detects an incorrect match, an error vector is transmitted to the server 310 and the protocol 301 is terminated. If the algorithm detects a match, the authentication protocol 301 continues. Using Rijndael in CBC-MAC mode, the shared secret key K is created by hashing the fingerprint template using a pre-stored 128-b key generator value KG according to K=HASH_{KG} (template). (Alternatively, the value of K can also be pre-stored in the embedded device.)

In one embodiment, after loading the received values of RAND and AMF, the thumbpod 200 loads OP and uses the secret key K and Rijndael primitives to generate:
OP_{C}: an encrypted operator code (optionally pre-stored). In one embodiment OP_{C} is at least 128-bits.
AK: an anonymity key to unmask the counter value CTR_{AS}. In one embodiment AK is at least 128 bits.
CTR_{AS}: a counter value of the server. In one embodiment CTR_{AS} is at least 48 bits.
XMAC_{TP}: an expected message authentication code of the server to prove its identity to the thumbpod 200. In one embodiment XMAC_{TP} is at least 64 bits.
RES_{TP}: a response of the Thumbpod 200 to prove its identity to the server. In one embodiment RES_{TP} is at least 64 bits.

CK (optional): a cipher key to allow for streaming encryption after authentication is performed. In one embodiment CK is at least 128 bits.

IK (optional): an integrity key to allow for optional data integrity and origin authentication of streaming encryption data. In one embodiment IK is at least 128 bits.

If the message authentication code generated by the server (MAC_{AS}) is equal to the message authentication code generated by the thumbpod 200 (XMAC_{TP}), then the identity of the server 310 is authenticated. If they are unequal, then the user immediately recognizes that either the transaction register or the server is fraudulent.

If the counters of the server 310 and the thumbpod 200 are synchronized, then the process continues. If the counters are not synchronized but the MAC test passes, the system enters into re-synchronization mode to restore synchronization.

If the two authentication tests are passed, the thumbpod 200 sends a response vector RES_{TP} to the transaction register 401, which forwards this vector to the authentication server 310.

To complete the protocol, the authentication server 310 verifies that XRES_{AS}=RES_{TP}. If the values are not equal, it immediately indicates a fraudulent user or fraudulent thumbpod 200, allowing the server 310 to act accordingly. If these values are equal, then the identities of the thumbpod 200 and the user 310 are verified by the server 310. Hence, the protocol 301 provides mutual authentication between the server and the thumbpod 200. After verification of the user's identity, the server 310 increments its local counter variable SQN_{AS} and sends a transaction-complete vector to the transaction register 401. The register 401 then completes the transaction by printing a receipt and forwarding the transaction complete vector to the thumbpod 200. The thumbpod 200 increments its local counter variable SQN_{TP} to conclude the authentication protocol 301.

Four functions require a relatively large amount of computation in the thumbpod 200: 1) authentication vector generation, 2) feature extraction, 3) template matching, and 4) the key generation hash function.

The protocol 301 and the thumbpod 200 can use any robust encryption method. In one embodiment, the cryptographic engine used in the thumbpod 200 is the Rijndael algorithm (e.g., using a 128-b key and 128-b data), otherwise known as the Advanced Encryption Standard (AES). In one embodiment, Rijndael was chosen for security considerations and the absence of any known vulnerabilities to attack. The Rijndael kernel is used in three configurations: ECB, CBC-MAC, and OFB/Counter for optional streaming encryption applications.

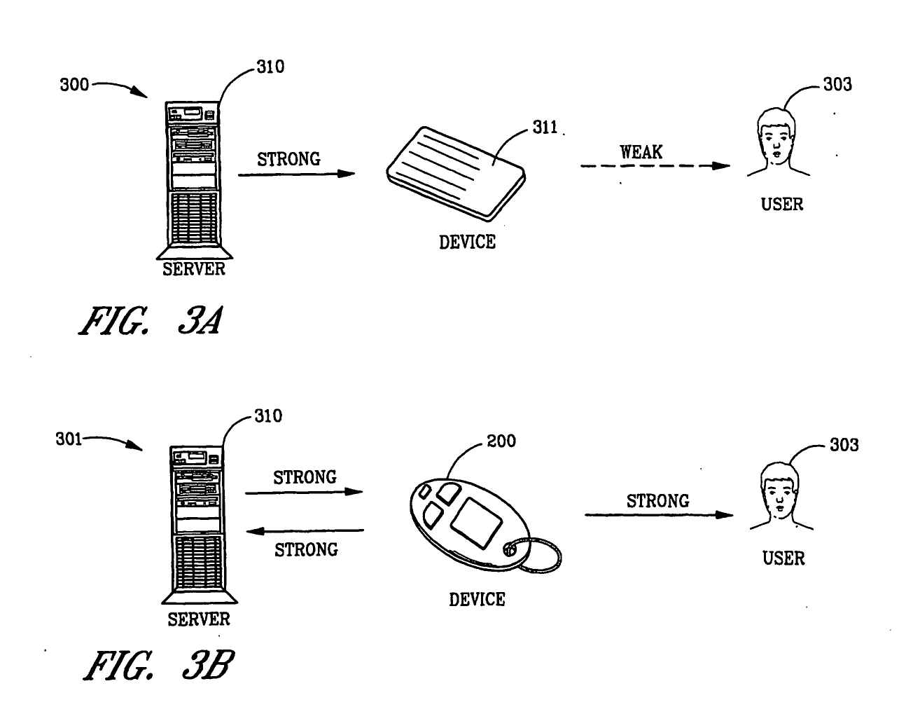

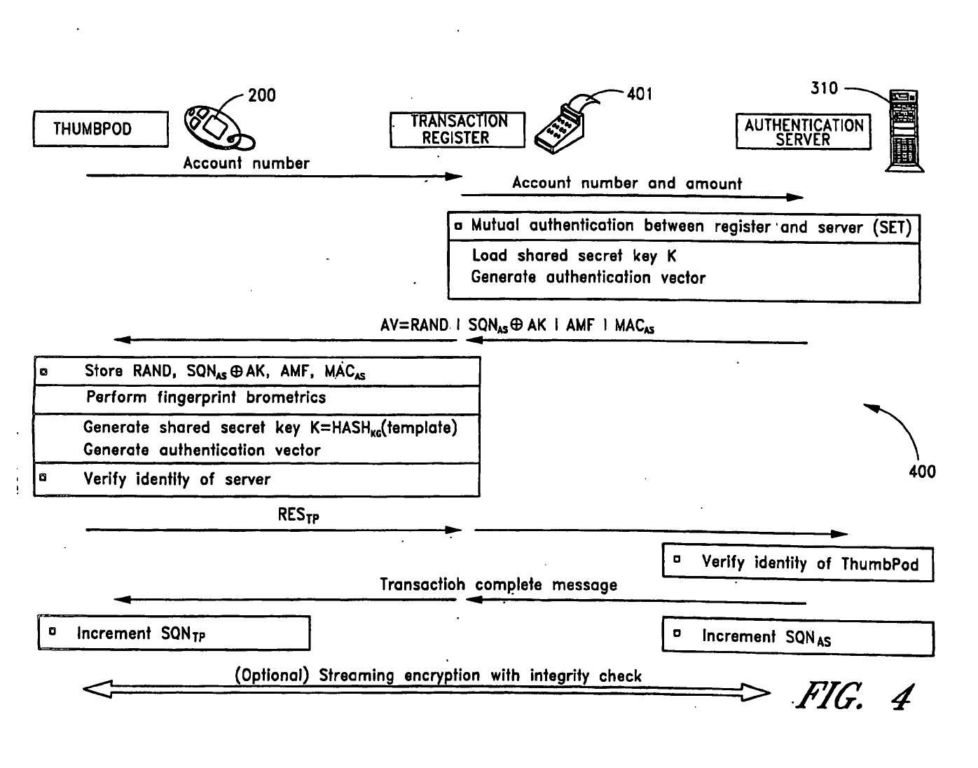

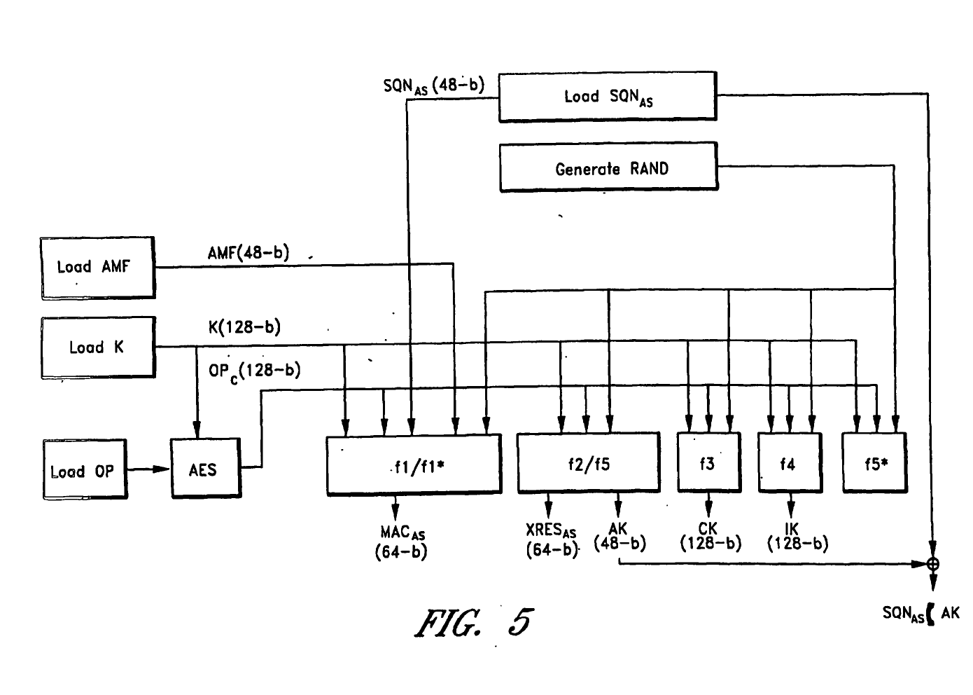

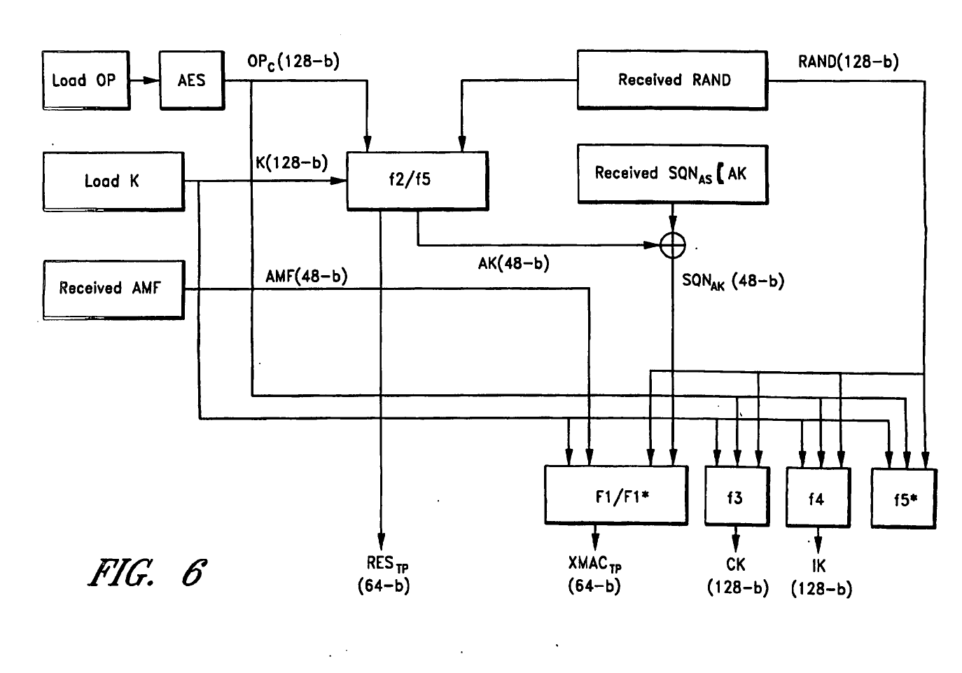

In one embodiment, the generation of authentication vectors in the server 310 is shown in FIG. 5, and the generation of authentication vectors in the thumbpod is shown in FIG. 6. Rijndael EBC mode is used to generate the authentication vectors in both the authentication server 310 and in the thumbpod 200, as described above and based on the 3GPP authentication protocol. After loading the particular initialization values, the following functions are used to extract the vector components:
f1: generation of MAC_{AS}/XMAC_{TP} message authentication code.
f2: generation of RES_{TP}/XRES_{AS} response.
f3: (optional) generation of CK cipher key for streaming encryption.
f4: (optional) generation of IK integrity key for integrity protection of streaming encryption data.
f5: generation of AK anonymity key.
f1*/f5*: generation of vectors for re-synchronization.

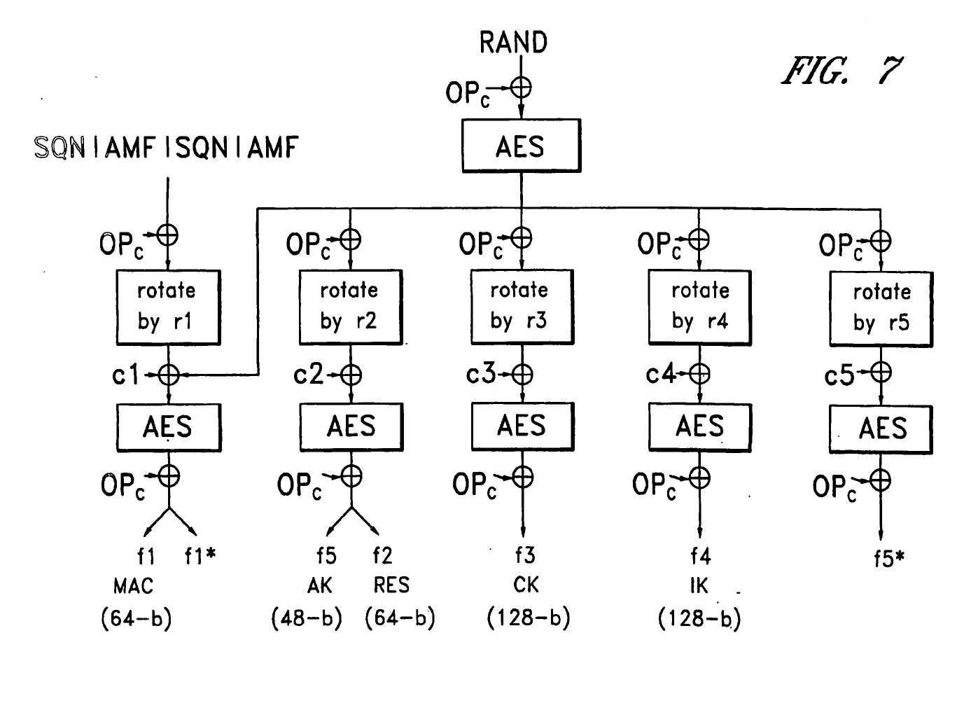

A closer examination of the functions f1-f5 is provided in FIG. 7. The functions primarily encrypt the random value RAND using Rijndael ECB modules (with the secret key K) and wrap the Rijndael engine with various XOR modules and fixed rotations. In FIG. 7 the variables c1-c5 and r1-r5 are constant-bit vectors and the OP_{C} value is the operator code encrypted by the secret key K. The generation of one set of authentication vectors involves six (seven including the encryption of OP_{C}) iterations of the Rijndael ECB engine.

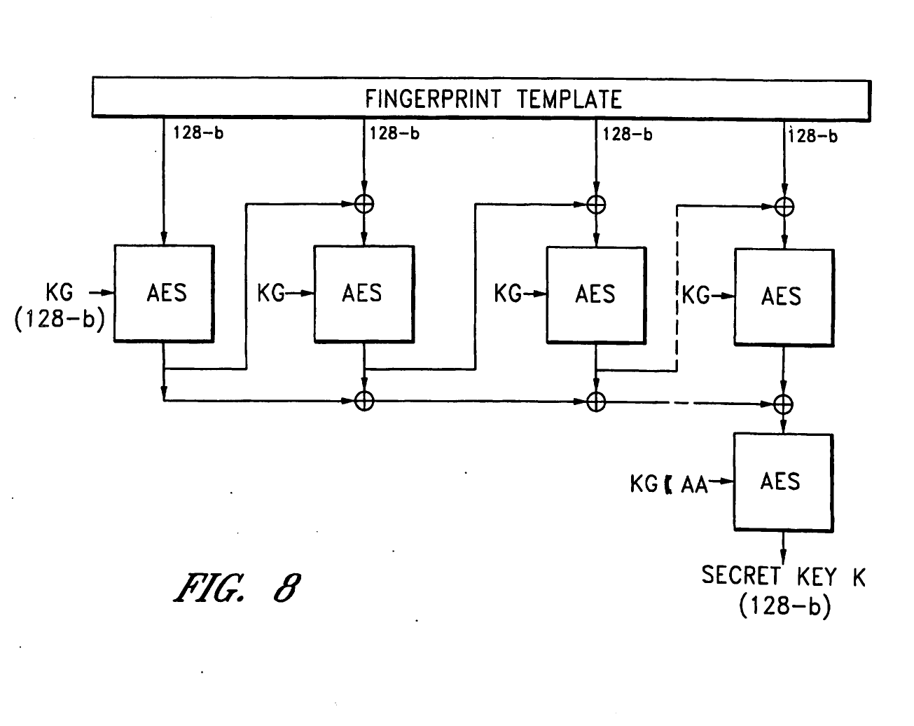

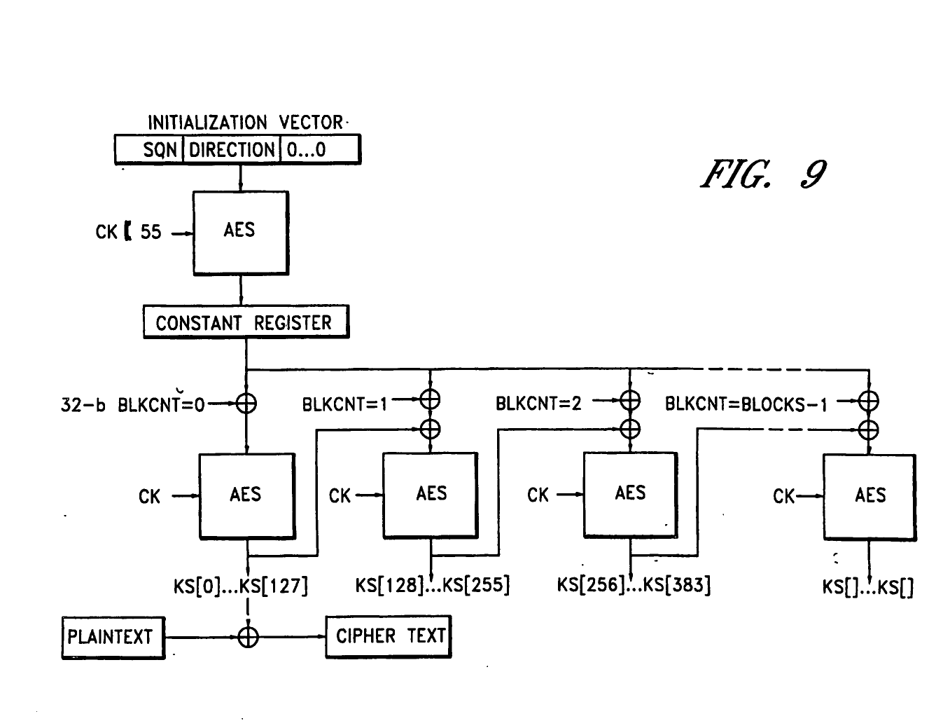

FIG. 8 is a block diagram of the Rijndael CBC-MAC algorithm. Rijndael is used in a variant of CBC-MAC mode to generate the keyed-hash function K=HASH_{KG}(template), as seen in FIG. 9. The key generation value KG is used as the key for the Rijndael core. In one embodiment, the fingerprint template (5,120 bytes) is loaded as the input value to the encryption module 128 bits at a time. The 128 bit segment is encrypted and the output is both forwarded to be XOR'd with the next template segment as well as the next encryption output, a technique known as cipher block chaining (CBC). After the final template segment, the 128 bit value is encrypted once again with a special key (KG XOR'd with a string of hexadecimal A=1010|1010|1010 . . . values) and the output value is the message authentication code (MAC), otherwise known as a keyed-hash (to avoid ambiguity with the aforementioned MAC value). The CBC-MAC function is invoked for 40+1 iterations in order to hash the entire fingerprint template. The same function is used with the integrity key IK in order to provide integrity protection of messages send with streaming encryption.

FIG. 9 is a block diagram of the Rijndael OFB-Counter algorithm. For applications which require high-speed transmission and encryption of data, the Rijndael core is configured as a keystream generator to form a stream cipher, as seen in FIG. 9. The keystream is XOR'd with the plaintext data to be encrypted, producing a ciphertext stream which is sent over an insecure channel. At the server side, the same keystream is produced and XOR'd with the ciphertext to produce the original plaintext. The keystream generator functions as follows. First an initialization vector is created, which is composed of the sequence number SQN concatenated with a direction bit (1 for uplink, 0 for downlink), followed by padding zeroes. The cipher key CK (generated during authentication) is XOR'd with a string of hexadecimal values of value 5=0101|0101| . . . and used as a key to encrypt the initialization vector. The ensuing value is a constant register used as a data kernel to drive the stream cipher. After the required keystream length is determined, the length is divided into a number of 128 bit blocks. Each keystream block is formed by XORing the constant register with the previous encryption output (output feedback—OFB) and with a counter module, which increments at each iteration. The keystream is then XOR'd with the plaintext block to produce a 128 bit block of ciphertext. The final XOR of plaintext utilizes only the required number of bits, which is maximally 128 bits. In one embodiment, a single Rijndael cryptographic co-processor described below is provided for the three Rijndael configurations (ECB, CBC-MAC, OFB-Counter) and which is capable of being configured in each of the modes.

The protocol 301 is resistant or immune to the following cryptographic attacks: false register or false authentication server attack, stolen account number authentication attack, stolen account number synchronization attack, multiple synchronization attempts attack, stolen thumbpod attack, timeout attack, and incorrect data format transmission attack.

One aspect of the protocol 301 is the key generation function, which traverses security issues found in prior art biometric systems. A deficiency with biometrics in general is the issue of true identity theft: once a biometric identity (fingerprint, iris scan, etc.) is stolen, it is forever compromised, as a person possesses only a finite number of biometric templates. Although the thumbpod 200 can be housed in a tamper-proof casing, in one embodiment, the biometric template in the thumbpod is stored in a matter that prevents biometric data from being extracted from a stolen thumbpod 200.

In one embodiment, the thumbpod 301 uses a key generation concept whose security relies on both a static component (e.g., fingerprint template) and a dynamic component (a key generator variable), K=HASH_{KG}(template). The shared secret key K is obtained by using a KG as the key for the Rijndael CBC-MAC engine, which operates on the user fingerprint template (5,120 bytes). This is similar, at least in principle, to a split-key security system, where two users possess separate, different keys and both keys are necessary to activate the device in question. Prior art biometric authentication systems merely require a template match in order to allow access, and a stolen template gives a criminal full access to the user's identity.

If the thumbpod 200 is lost or stolen, for precautionary measures, the user 303 would notify his/her financial institutions to request a new KG. After obtaining a new thumbpod 200 and enrolling a new template, a new secret key K would be generated, rendering the old key useless. Hence, in the case that a criminal obtains the user's fingerprint template from a thumbpod 200, the system is not entirely compromised due to the split-key key generation function. Another security benefit of the split-key generation model is that the server 310 never receives a copy of the user's template; it only stores the current secret key K. Due to the one-way property of hash functions, a stolen secret key K would not allow a criminal to re-generate the user's fingerprint template, even with knowledge of the key generator KG. This localization of sensitive data, rather than a widespread distribution of biometric data to each financial institution, allows for both psychological as well as cryptographic security.

Since the thumbpod 200 performs biometric identification, relatively computation-intensive biometric signal processing is typically required for both the feature extraction and matching algorithms. Designing for secure embedded systems results in partitioning which is based not only on communication-computation tradeoffs, but also partitioning which is based on security considerations. For example, though transmitting plaintext raw fingerprint data over the wireless channel would perhaps save energy in the thumbpod 200, it is insecure in that a passive attacker could listen on the channel and steal the fingerprint data. The following section describes the security-based partitioning of the biometric functions used for the protocol 301.

For purposes of explanation, and not by way of limitation, the thumbpod 200 is described in terms of six subsystems: 1) Data collection subsystem, 2) Signal processing subsystem, 3) Matching subsystem, 4) Storage subsystem, 5) Decision subsystem, and 6) Communication subsystem.

In one embodiment, the data collection subsystem includes the sensor 202. In one embodiment, the sensor 202 includes an Authentec AF-2 CMOS imaging sensor. An alternative placement of the sensor is within the merchant's transaction register 401. However, studies have shown the relative ease in which a fingerprint can be stolen from a traditional CMOS sensor. Hence, placing a sensor on the transaction register 401 presents a security risk in that a fingerprint can be easily stolen by a malicious merchant or another consumer. As for the resolution of the CMOS sensor, it is chosen based on consideration of security strength and system cost. In some embodiments, the size of thumbpod 200 limits computational power and energy consumption, thus the collected data from CMOS sensor is sized to be precise enough to obtain a reasonable matching result but small enough to meet a system requirement in such an embedded system.

The raw data collected by the sensor 202 is processed to extract biometric features for identification. In a fingerprint verification system, the features to be extracted are the minutiae type (ridge or bifurcation) and the location of the minutiae via a process is known as feature extraction or minutiae detection. In one embodiment, the thumbpod 200 uses the standard floating-point C NIST detection algorithm.

In one embodiment, the thumbpod 200 uses a fixed-point variation of the well-known standard floating-point NIST detection algorithm. There are several steps in the minutiae extraction algorithm, many of which require significant signal processing. The first step is to generate image quality maps, which include the detection of fingerprint ridge directions, image refinement, and detection of low contrast areas, which are assigned lower quality factors. A binarization of the image is generated, and the detection algorithm scans this binary image of the fingerprint to identify localized pixel patterns that indicate the ending (ridge) or splitting of a ridge (bifurcation). In one embodiment, a fixed-point refinement and table lookup of mathematical functions are used to reduce the computational and energy burdens.

The matching subsystem includes a set of algorithms used to match a pre-stored fingerprint template (or multiple fingerprint templates) with a candidate fingerprint obtained from the sensor. After extracting the minutiae of the fingerprint, two steps are used to estimate the similarity of the input minutiae set and the template minutiae set. The first step is to discover the correspondence of these two minutiae sets. For each minutia, the distance and relative direction to its neighborhood is taken as its local structure. Since this local structure is rotation and translation invariant, it is used to choose the corresponding pair in the input and template minutiae sets. The second step is to align the other minutiae by converting them to a polar coordinate system based on the corresponding pair, then computing how similar the overall minutiae distributions are in the input pattern and template pattern. The total similarity is represented by matching score. For security reasons, the matching algorithm is embedded within the thumbpod 200. Thus, sensitive minutiae data is not required to be transmitted over the channel.

The storage of the fingerprint template is also partitioned onto the thumbpod 200. The template is stored on-device in order to localize the most sensitive information in the entire system—the user's fingerprint information. If the template is distributed to various financial institutions, a breech in only one system would cause a loss of the user's template data. The aforementioned split-key generation function, coupled with the template storage on the thumbpod 200, is used to address this security issue.

The decision subsystem receives the results of the matching algorithm and makes a decision based on a pre-defined correlation score

Since the biometric subsystems are embedded within the thumbpod 200 device, it allows for the communication subsystem to transmit data across an insecure wireless channel. The only unencrypted sensitive data sent over the channel is the initial account information required to begin the authentication protocol. All other transmitted information is either encrypted or irreversible (one-way hash values used for authentication verification).

The aggregate result of this system partitioning allows for two unique system characteristics. First, the protocol describes a biometric authentication system in which no biometric information is transmitted across any medium, wireless or wired. Second, as previously mentioned, the biometric data is stored only in the thumbpod 200 and not in any financial institution server. The localization of sensitive data minimizes the cost of breeches in the entire security context.

Fingerprint Identification

In one embodiment, the algorithm used to extract minutiae of the fingerprint image is originated from NIST Fingerprint Image Software. FIG. 10 is a block diagram showing the flow of the fingerprint identification algorithm. The fingerprint data is provide to a map generation block and to a binarization block 1005. The map generation block 1004 generates direction maps and quality maps that are provided to the binarization block 1005. The binarization block 1005 generates a binarized image that is provided to a detection block 1006. The detection block 1006 identifies possible minutiae and provides the possible minutiae set to a removal block 1007. The removal block 1007 removes false minutiae from the set of possible minutiae and generates a final minutiae set.

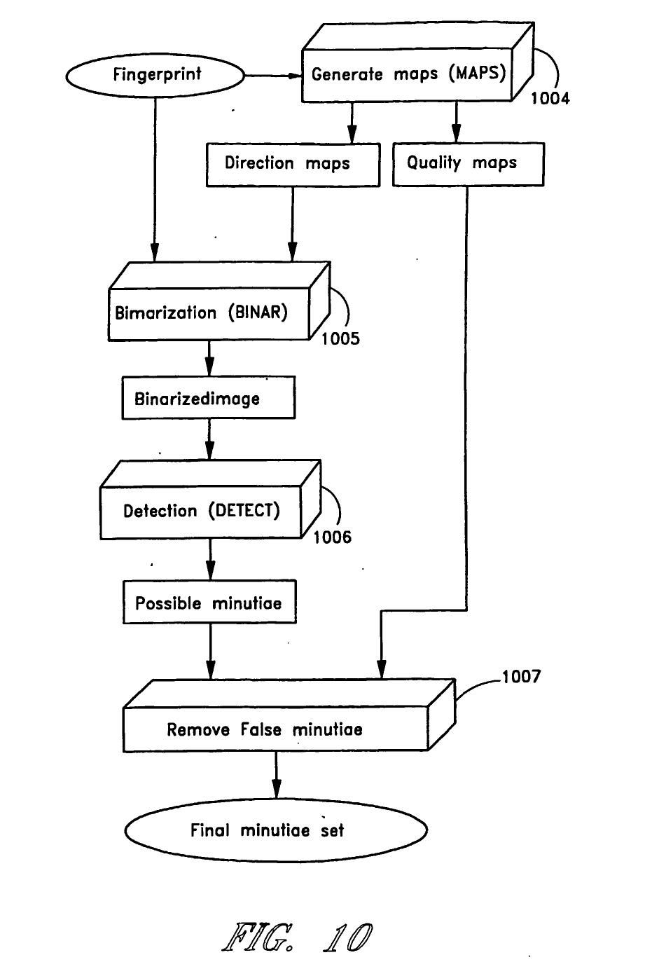

The minutiae detection process is based on finding a directional ridge flow map. To get this map, the fingerprint image (e.g., 256×256 pixels) is first divided into a grid of blocks (e.g., 8×8 pixels). For each block, there is a surrounding window (e.g., 24×24 pixels) centered by this block. For each block, the surrounding window is rotated incrementally and a DFT analysis is conducted at each orientation. In one embodiment, the number of orientation is set to 16, creating an increment in angle of 180°/16, i.e. 11.25°. Within an orientation, the pixels along each rotated row of the window are summed together, forming a vector of 24 pixel row sums. The 16 orientations produce 16 vectors of row sums, as shown in FIG. 11.

The resonance coefficients produced by convolving each of the 16 row sum vectors with the 4 different discrete waveforms are stored and then analyzed. The dominant ridge flow direction for the block is determined by the orientation with the maximum waveform resonance calculated from Equation (1):

$$E ( k , θ ) = {\vert {\sum }_{n = 0}^{23} row\_sum ( n , θ ) {W}^{kn} \vert}^{2} , \\ W = exp ( \frac{- jπ}{16} ) \\ ( k = 1 , 2 , 3 , 4 ) \qquad ( 1 )$$

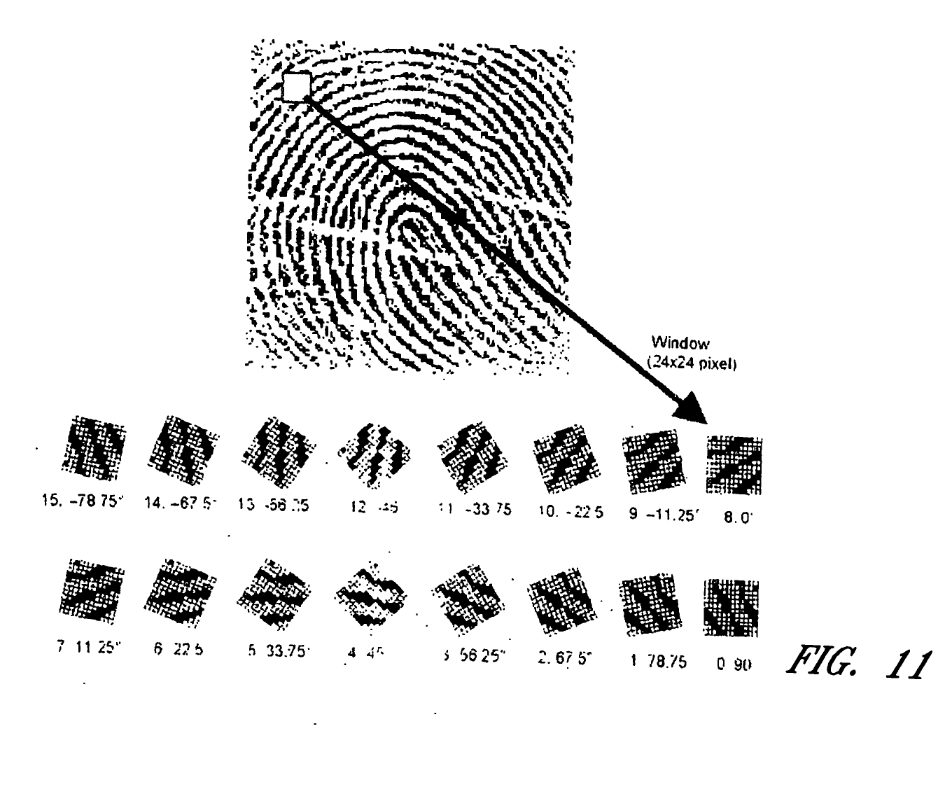

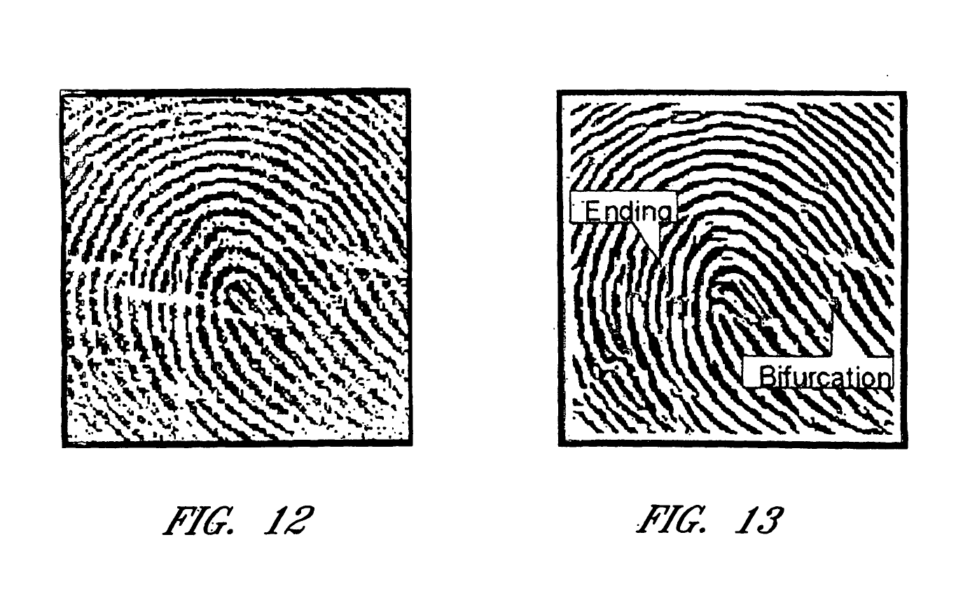

Each pixel is assigned a binary value based on the ridge flow direction associated with the block to which the pixel belongs. Following the binarization 1005, the detection block 1006 scans the binary image of a fingerprint, identifying localized pixel patterns that indicate the ending or bifurcation of a ridge. FIGS. 12 and 13 show the original and binarized images respectively. By performing this scanning, minutiae candidates are identified. The removal block 1007 removes false minutiae.

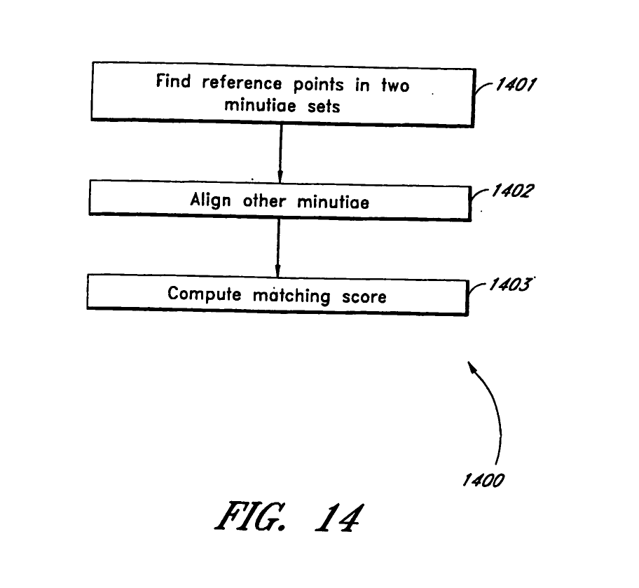

After two minutiae sets (e.g., an input fingerprint image and a template fingerprint image, respectively) are extracted, the matching algorithm can be described. FIG. 14 is a block diagram showing the matching process 1400 used to determine if there is a match between the two minutiae sets.

The first step 1401 in the algorithm 1400 is to find out the correspondence of these two minutiae sets. Each minutia, N, can be described by a feature vector: N=(x,y,φ,i), where (x,y) is its coordinate, φ is the local ridge direction and t is the minutia type (ridge ending or bifurcation). However, x,y and φ cannot be directly used for matching because they are dependent on the rotation and translation of the fingerprint. To solve this problem, it is useful to construct a rotation and translation invariant feature:
M=(d₁,d₂,θ₁,θ₂,φ₁,φ₂,n₁,n₂,t,t₁,t₂) (2)

FIG. 15 graphically shows the details of this local feature, where n₁=0 and n₂=1. Assume Mₗ(i) and M_{T}(j) are the local feature vectors of the ith minutia of the input fingerprint and the jth minutia of the template fingerprint, respectively. A similarity level can be defined:

$$sl ( i , j ) = \{ \begin{matrix}1 - \frac{{\vert {M}_{I} ( i ) - {M}_{T} ( j ) \vert}_{W}}{A} , & if {\vert {M}_{I} ( i ) - {M}_{T} ( j ) \vert}_{W} < A ( W ) \\ 0 , & otherwise\end{matrix} \\ i = 1 , 2 … p \\ j = 1 , 2 … q \qquad ( 3 )$$

where p and q are the numbers of minutiae in the input fingerprint and the template fingerprint, respectively. |Mₗ(i)−M_{R}(j)|_{W} is the weighted difference of Mₗ(i) and M_{T}(j). A(W) is the threshold which is related to the weight vector W. Set W=(1,1,8,8,8,8,3,3,⅓,⅓,⅓) and A(W)=55. By searching of sl(i,j), one pair (b₁,b₂) can be obtained so that

$$sl ( {b}_{1} , {b}_{2} ) = {max}_{i , j} ( sl ( i , j ) ) .$$

The next step 1402 is to align the other minutiae by converting them to a polar coordinate system based on the corresponding pair (b₁,b₂). For minutia N, the new polar coordinate is M^{p}=(r,θ,φ), where

$$r = \sqrt{{( x - {x}_{b} )}^{2} + {( y - {y}_{h} )}^{2}} \\ θ = diff ( arctan ( \frac{y - {y}_{h}}{x - {x}_{b}} ) , {φ}_{h} ) \\ φ = diff ( φ , {φ}_{h} ) \qquad ( 4 )$$

The function diff( ) is the difference between two angles. Based on the aligned minutiae sets, we can compute the matching level of each minutia in the input fingerprint and each one in the template fingerprint:

$$ml ( i , j ) = \{ \begin{matrix}i - diff\_total , & diff\_total < Bg \\ 0 , & otherwise\end{matrix} \qquad ( 5 )$$

In Equation 5, diff_total=|Mₗ^{p}(i)−M_{T}^{p}(j)|_{W}_{^{p}}. Bg is a bounding box where Bg=(8,π/6,π/6) and W^{p}=(1,8,8).

To avoid one minutia being used more than once for matching, ml(i,j) is set to “0” if there is any k that make ml(i,k)>ml(i,j) or ml(k,j)>ml(i,j). Afterwards, the final matching score can be calculated by:

$$Ms = 100 \times \frac{{\sum }_{i , j} ml ( i , j )}{max ( p , q )} \qquad ( 6 )$$

The algorithm 1400, provides fingerprint verification on thumbpod 200. In one embodiment, the sensor 202 used for fingerprint scanning has relatively small area (13×13 mm²), so the performance is relatively strongly dependent on which part of the finger is captured by sensor. In one embodiment, the thumbpod 200 uses a two-template system to deal with the small sensor area. The fingerprint image sets (templates) used by the thumbpod 200 include 10 fingerprints per finger from 10 different fingers for a total of 100 fingerprint image templates. Each fingerprint is compared with every fingerprint template in pairs, and the two match scores from each pair are ported into a decide engine in order to get the final matching result. A total of 7,200 decisions involved for the matched case and a total of 81,000 decisions are involved for the mismatched case. The size of captured image is 256×256 pixels. In one embodiment, the thumbpod 200 provides a 0.5% FRR (False Rejected Rate) and a 0.01% FAR (False Accepted Rate).

Implementing the fingerprints minutiae detection and matching on an embedded platform such as the thumbpod 200 involves performance, speed, and low power tradeoffs, since the whole process needs to be finished in a relatively short time and the battery lifetime in such devices is limited.

Software optimization aims to reducing the cycle number of processors as well as the power consumption. To get better performance, the first step is to find out the hot-points of the system.

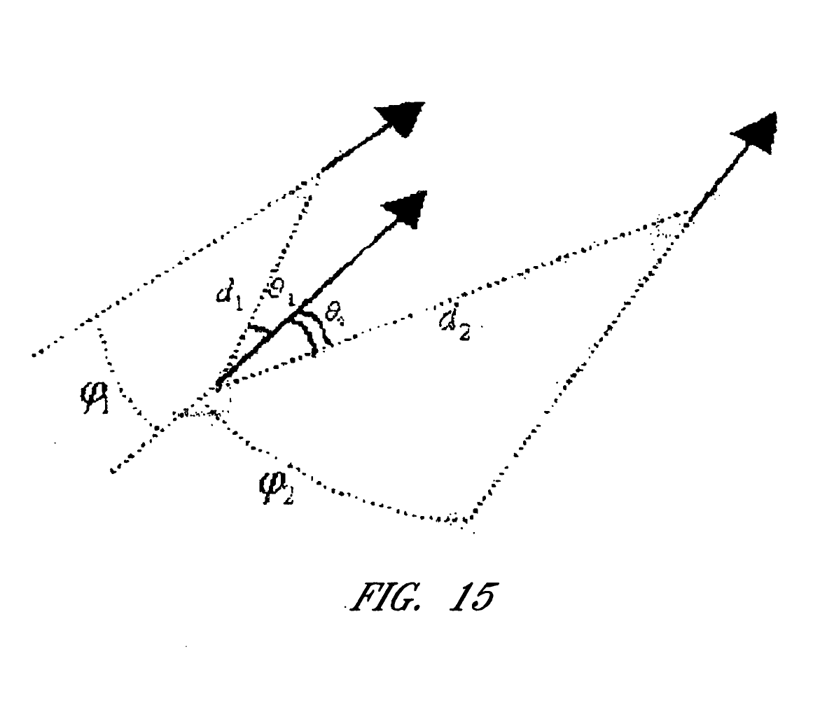

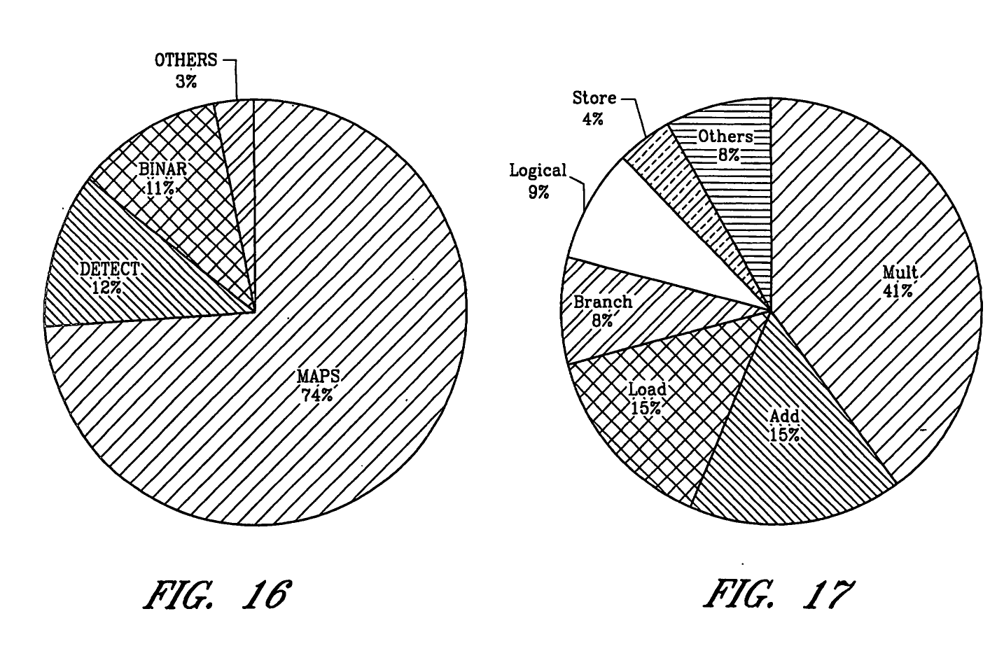

FIG. 16 shows performance profiling results. The execution time of BINAR 1005 and DETECT 1006 are 11% and 12% of the total, respectively. They are not considered to be system bottlenecks. By contrast, MAPS 1004 occupies 74% of the total execution time. Therefore, the detail algorithm is checked to speedup the MAPS in the instruction level. FIG. 17 shows the instruction-level profiling of MAPS. The number of instructions for multiply (Mult) and addition (Add) sum up to 56% of the total of the execution time due to the repetitive DFT calculation in creating the Direction Map. These Mult and Add instructions do not use any accesses to a memory. In other words, all accesses to the memory are included in Load and Store instructions that are 15% and 4%, as shown in FIG. 17B. Based on the profiling results, software optimization and/or hardware acceleration should be considered for the DFT calculations in MAPS of the minutiae detection.

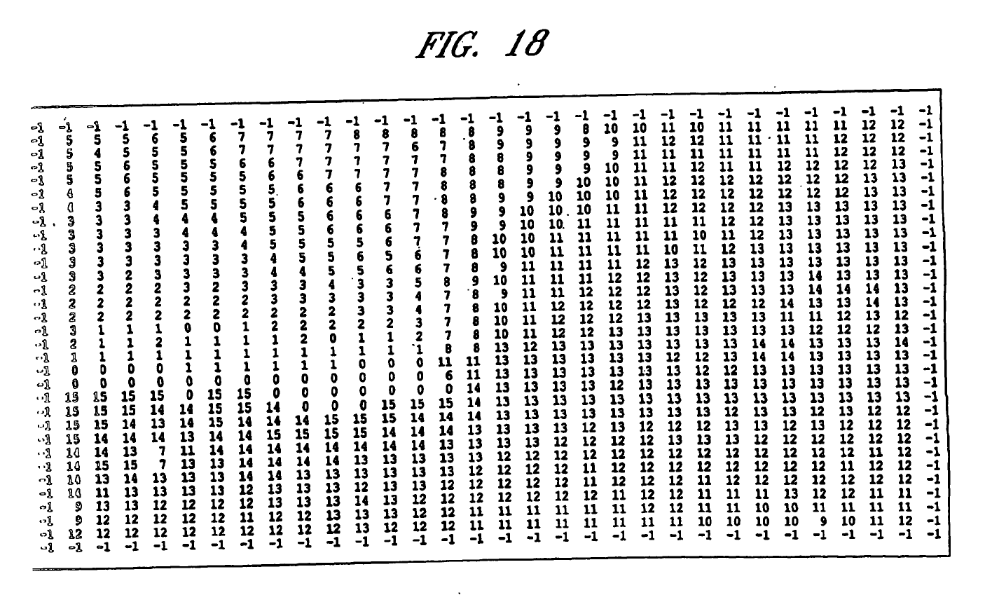

When considering the pattern of a fingerprint, the neighboring blocks tend to have a similar direction. In the example fingerprint map shown in FIG. 18, the second row shows gradual change of the direction data, from 5 (left) to 12 (right). Taking advantage of the characteristic, the number of the DFT calculation is reduced significantly.

The first direction data, upper left in FIG. 18, is calculated in the same method as the original program. When deciding the direction of the right data, the DFT for θ=4, 5, 6 is calculated first, because the result is most likely to be θ=5. If the total energy for θ=5 is greater than both its neighbors (θ=4, 6) and a threshold value (E_{TH}), the direction data of θ=5 is considered as the result. Otherwise, θ is incremented or decremented until the total energy for θ could have a peak with a greater value than E_{TH}. In other words, if the following three conditions are met, the calculation of the direction data is finished:

$$\begin{matrix}{\sum }_{k = 1}^{4} E ( k , θ ) > {\sum }_{k = 1}^{4} E ( k , θ - 1 ) & [ when θ = 0 , θ - 1 = 15 ] \\ {\sum }_{k = 1}^{4} E ( k , θ ) > {\sum }_{k = 1}^{4} E ( k , θ + 1 ) & [ when θ = 15 , θ + 1 = 0 ] \\ {\sum }_{k = 1}^{4} E ( k , θ ) > {E}_{TH} & \end{matrix} \qquad ( 7 )$$

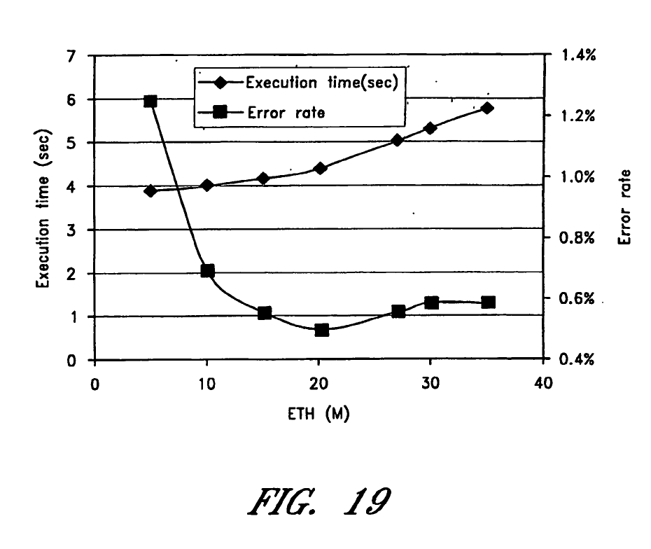

The execution speed as well as the matching error rate is measured when changing E_{TH} from 10M to 35M. The results are shown in FIG. 19. From the FIG. 19, it is found that when E_{TH} is larger than 20, the error rate is within an acceptable range.

The software optimization reduces the number of DFT and results in significant speedup of the minutiae detection. However, there are still more than 7,000 times of DFT calculations for 256×256 pixels image, even if setting E_{TH}=27M. Therefore, DFT hardware acceleration is useful in addition to the software optimization (FIG. 20).

The final specification of the accelerator is decided to deal with only Multiply/Accumulate (MAC) computations for sine and cosine part separately. In the Multiply operation, Canonic Signed Digit (CSD) is used for saving hardware resources. The energy calculation part is not included because it needs square operation of 16 bits data, which requires a general multiplier.

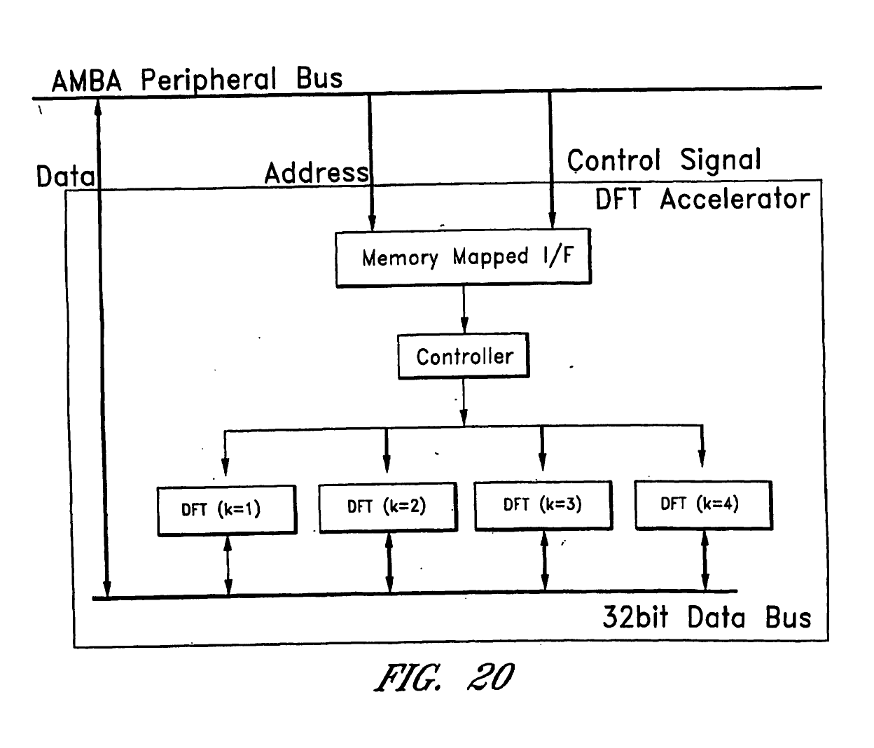

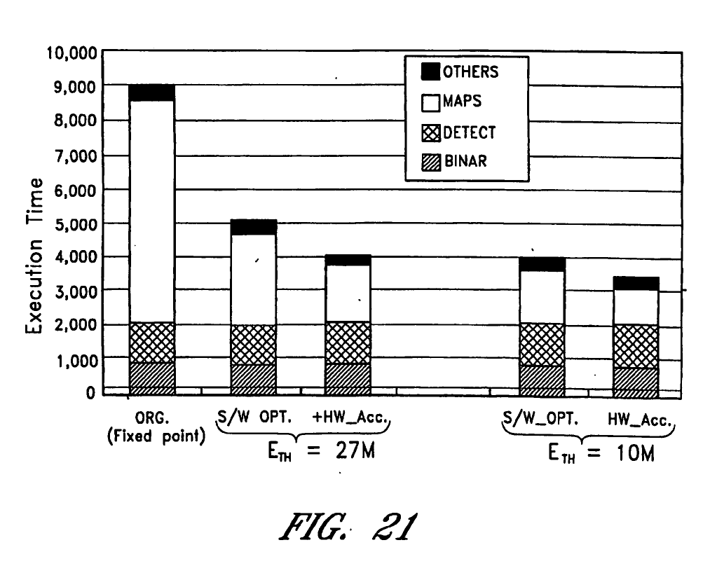

As a result, the execution time of the minutia detection is reduced to about 4 sec and 3 sec for E_{TH} is 27M and 10M, respectively as shown in FIG. 21. In the meantime, the energy consumption is reduced from 5,187 mJ to 2,500 mJ in case of E_{TH}=27M (FIG. 22).

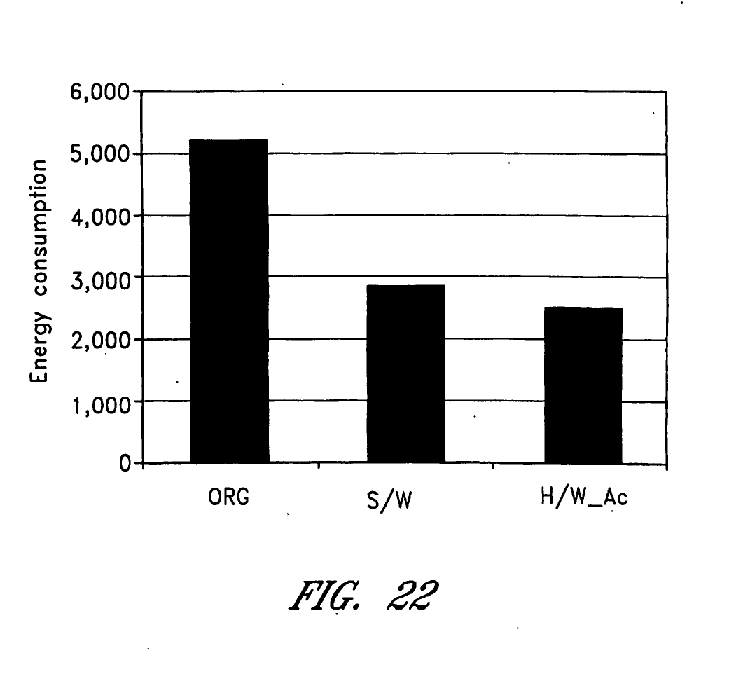

FIG. 23 shows the instruction cycle number distribution of the matching algorithm. Analysis of the profiling result shows that large part of the computation (52.2%) is used for finding the reference points for the input image and the template image. The reason for this is that when trying to find out which pair is the reference pair, thorough search for each (i, j) pair is conducted, where i=1 . . . p and j=1 . . . q. Totally p×q times of similarity level sl(i, j) need to be calculated. To obtain all of these sl(i, j), local feature vector M for each minutia in the input fingerprint as well as the template fingerprint needs to be calculated. Detailed study of one typical case shows that among all the sl(i,j), 89% of them is “0”, which means these pairs have total different neighborhoods and by no means can be the reference pair. In the process of calculating local feature vector M, the most time consuming part is finding the angles (θ₁,θ₂,φ₁,φ₂V) between the minutia and its neighborhood. To make the matching system more efficient, for those (i,j) pair whose sl(i,j) is 0, an earlier decision about whether this is a reference pair can to be made.

Thus in one embodiment of the thumbpod 200, a modified algorithm is implemented. In the modified algorithm, before calculating the real local feature vector, one additional module called “Pre-Checking” is added. For each pair of minutiae, the weighted difference |Mₗ(i)−M_{T}(j)|_{W} is calculated. In the Pre-Checking module, define W=W_{d}=(1,1,0,0,0,0,0,0,0,0,0), which means only the distance information is needed in this procedure. If the weighted distance |Mₗ(i)−M_{T}(j)|W_{^{d}} is within the pre-set threshold M_{TH}=A(W_{d}), then the computation of the complete local feature vector needed; otherwise, the complete local feature is not needed.

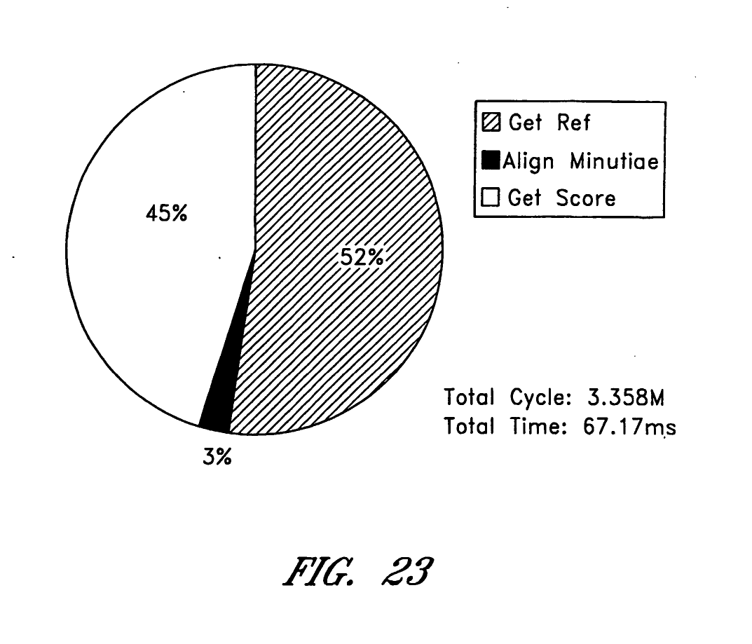

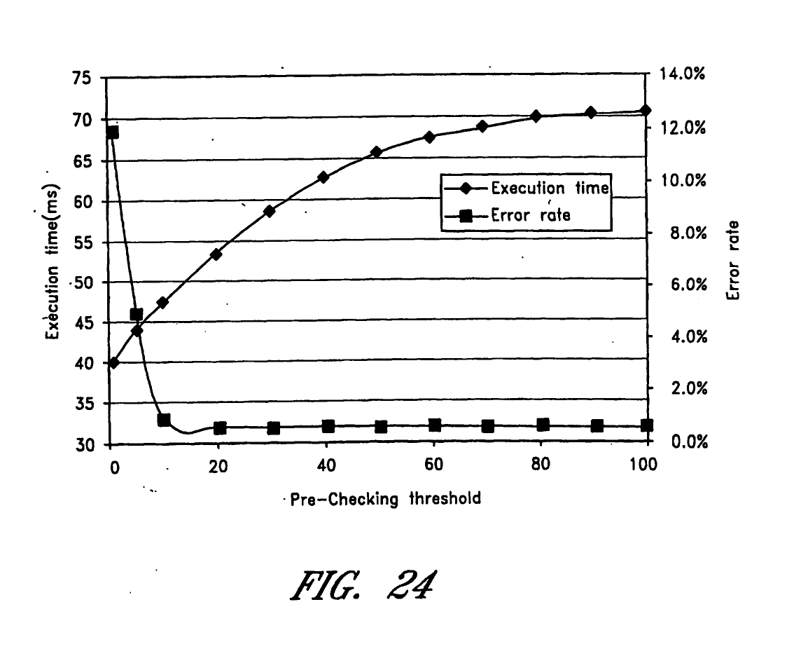

The computation time after adding the Pre-Checking module and the result degrade depends on the value of the threshold M_{TH}. The relationship between M_{TH} and the performance is shown in FIG. 24. As shown in FIG. 24, M_{TH} [symbol] 20 reduces computation time significantly, and yet provides a relatively low error rate.

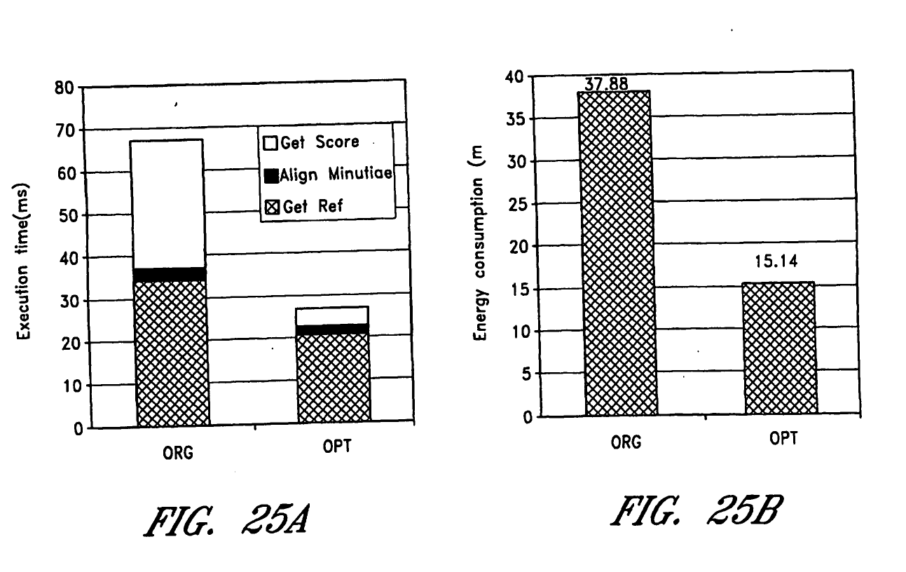

During the regular process of setting flags to the possible multiple-used matching level ml(i, j), one loop with a size of p×q×(p+q) is used, where q and p is the number of minutiae in the input and template fingerprints, respectively. For a sample case, where p=37 and p=39, the instruction cycle number to finish this process is 1.4M (million), which is 38.9% of the entire matching process. The value ml(i,j) is calculated from the local feature difference of the ith minutia in the input fingerprint and the jth minutia in the template fingerprint. For most of the pairs (i,j), the local feature vector is so different that ml(i,j) is 0, which means that it contributes nothing to the overall matching score. Based on this characteristic, the process of marking possible multiple-used ml(i,j) can be optimized. Whenever the ml(i, j) is “0”, all the remaining comparison steps can be skipped and the process can advance straight to the next pair. After the above optimizations, the total cycle number is 1.34M. Hence the execution time is reduced to 26.80 ms, as shown in FIG. 25A and the energy consumption decreases from 37.88 mJ to 15.14 mJ, as shown in FIG. 25B.

Thus, by implementing optimized minutiae detection and matching algorithms, as well as DFT hardware accelerator, execution time for the minutiae detection and matching process can be substantially reduced

Hardware/Software Acceleration Transparency

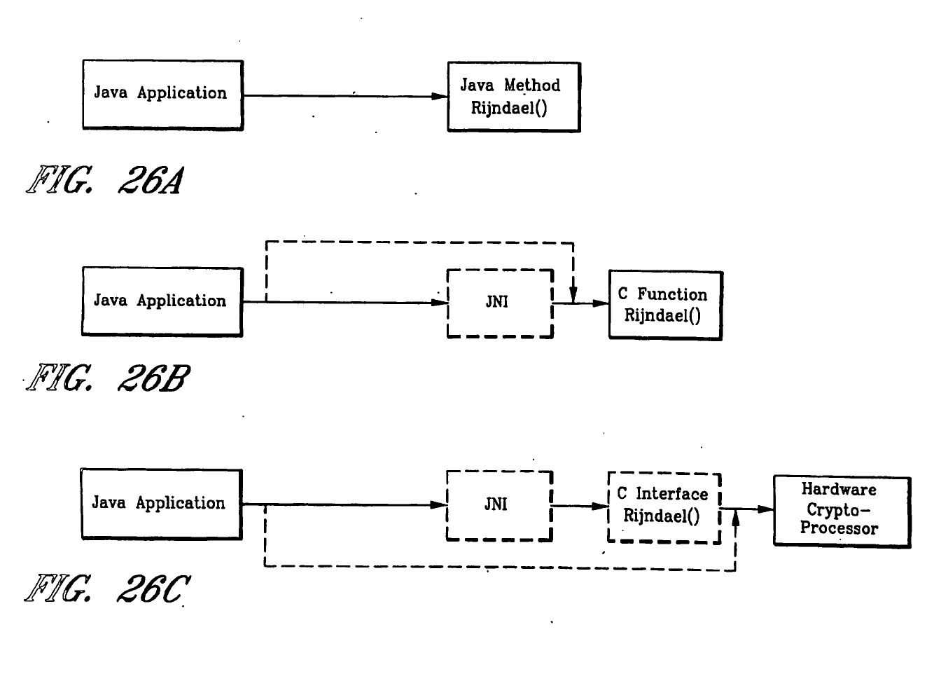

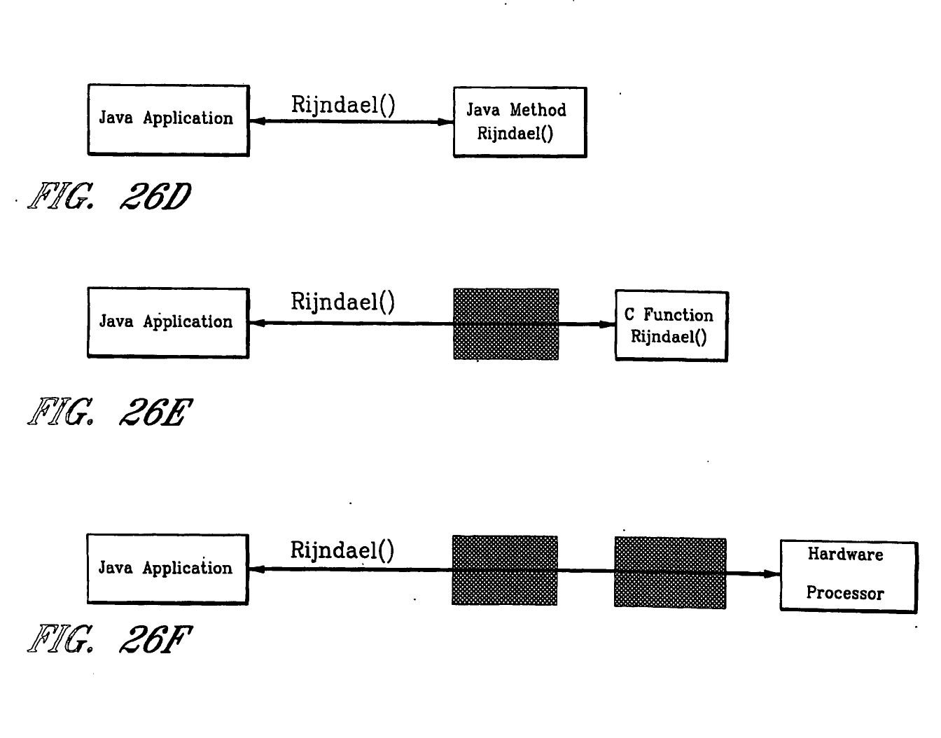

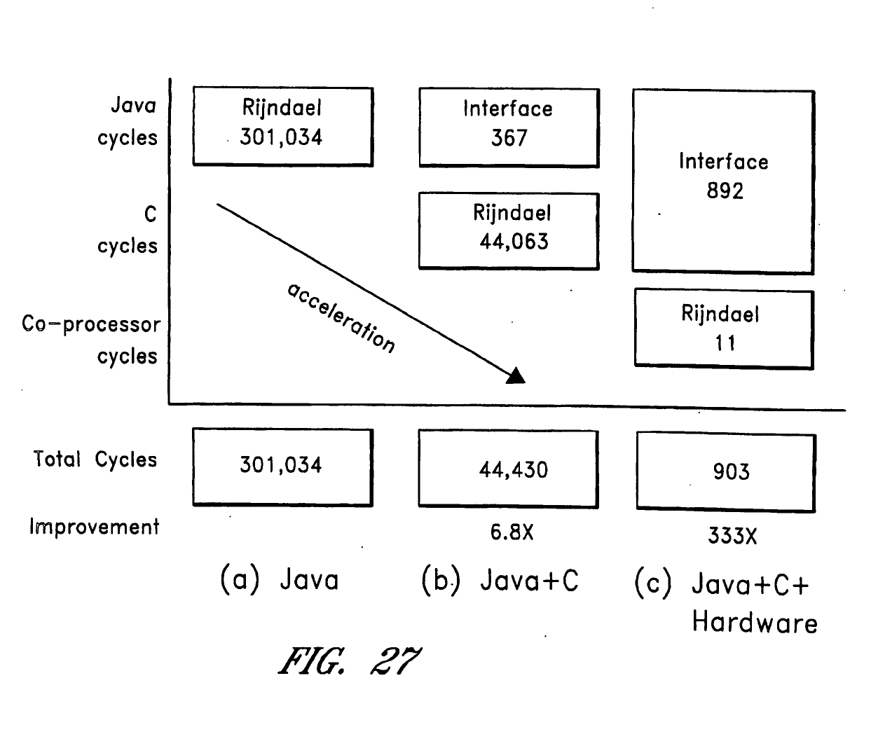

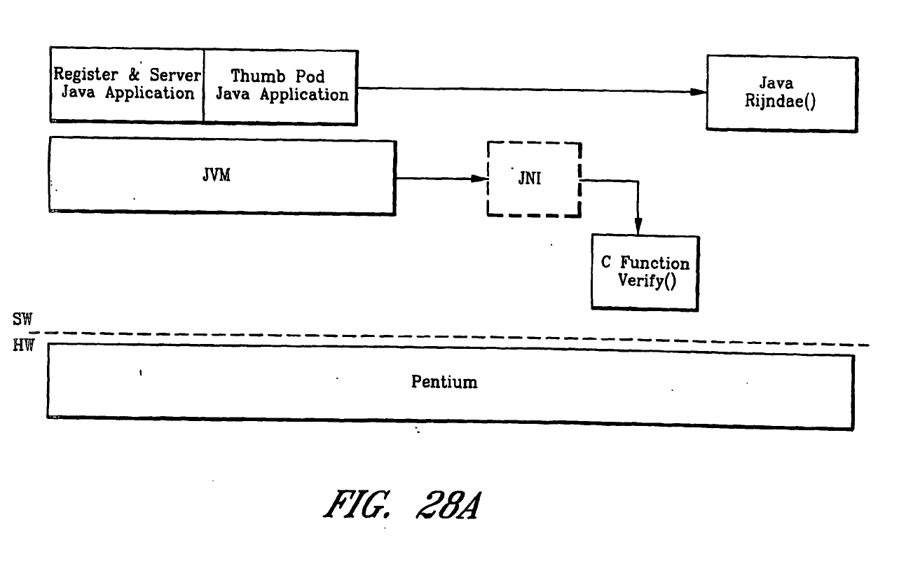

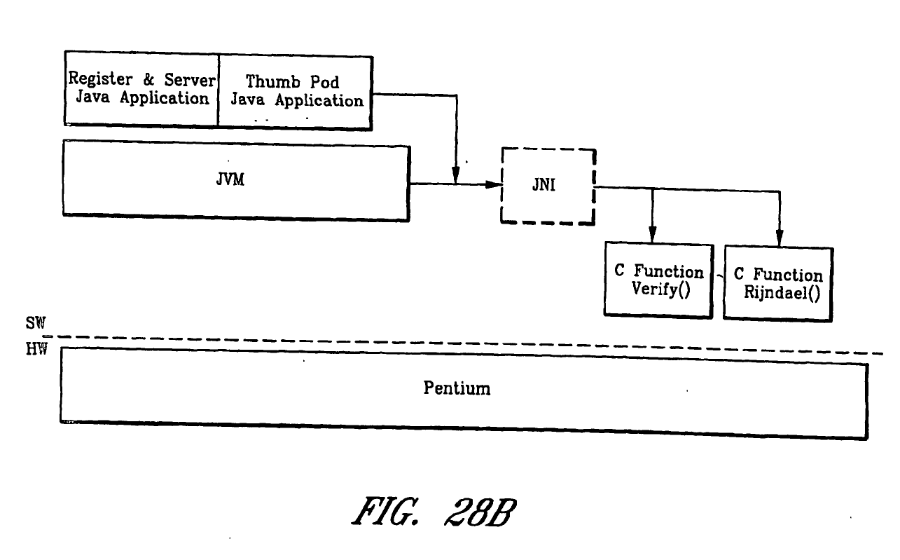

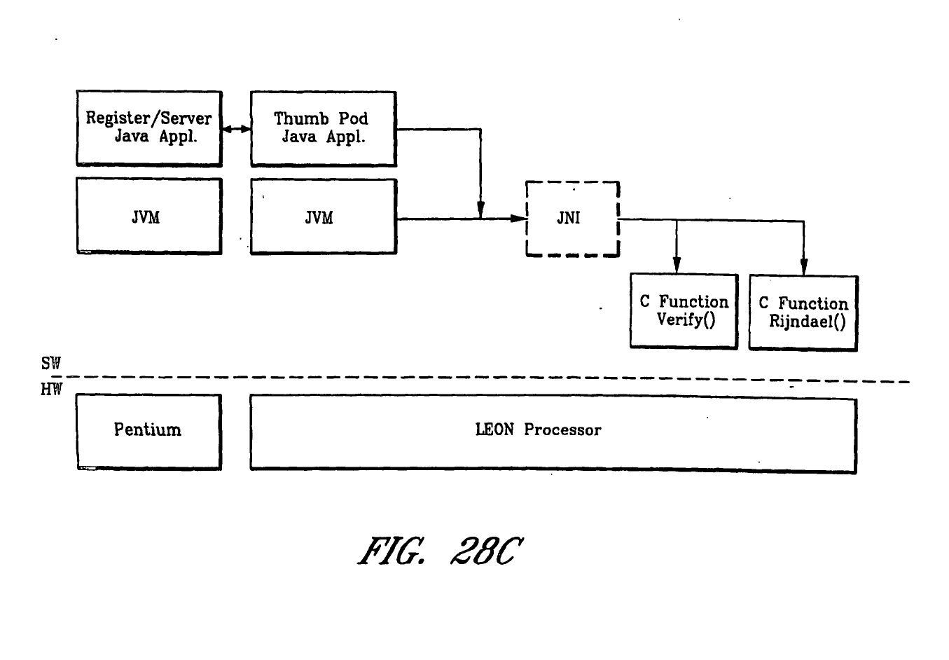

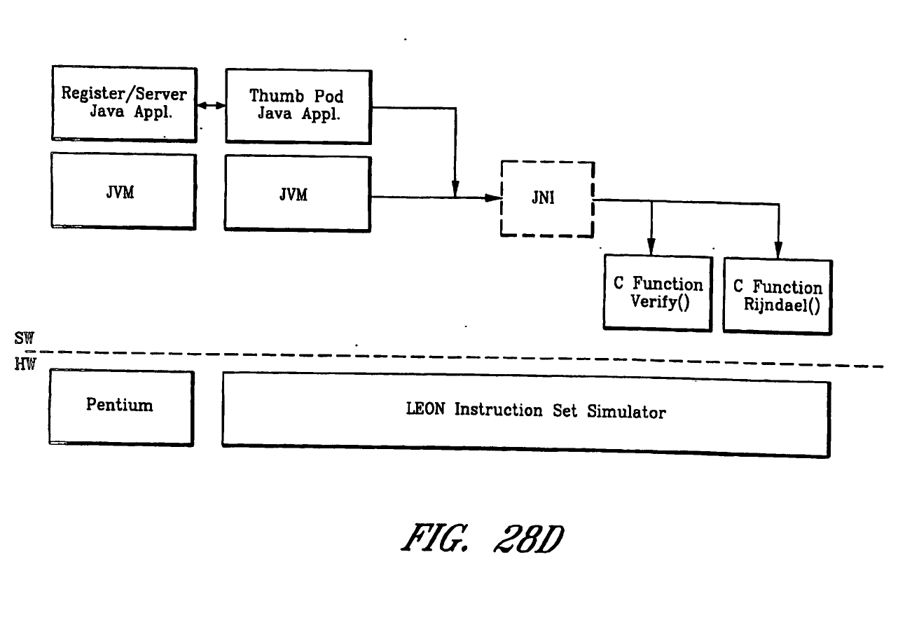

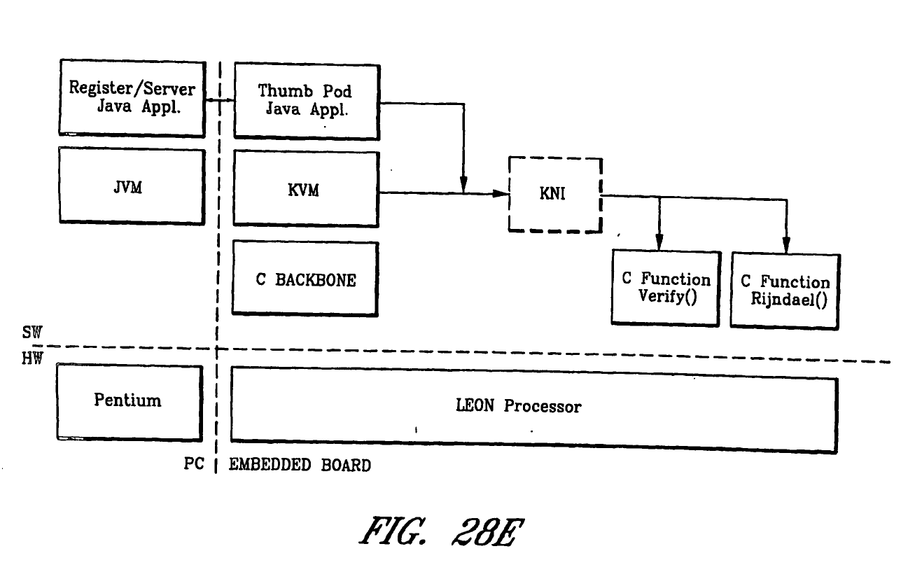

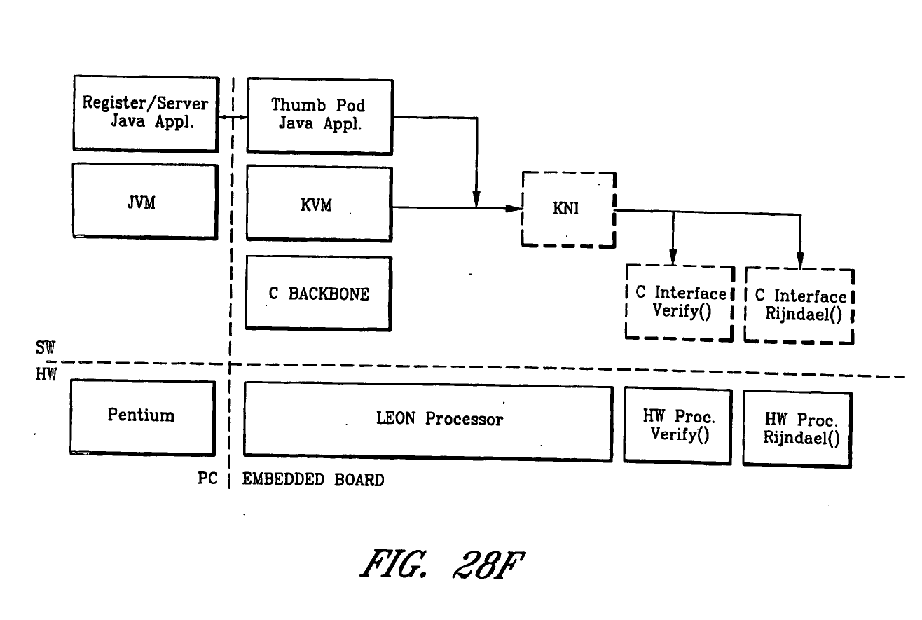

FIGS. 26A-26F show various embodiments of hardware or software acceleration transparency. In one embodiment, Java is used for its portability and security advantages. The issue of portability is important in embedded systems because of their high processor heterogeneity. Java's security advantages—such as a safe memory model, byte-code verification, cryptographic interface libraries, and the sandbox model—are important in the design of secure systems.

However, though advantages exist in these domains, Java is slower than its counterpart in C, and much slower than its counterpart in pure hardware. An example of Java's performance drawback can be seen in Table 1, where the 128 bit input, 128 bit key Rijndael function in Electronic Code Book (ECB) is performed. The Java (KVM) and C figures are on a 1 mW/1 MHz Sparc processor. This configuration is used to emulate an embedded environment. The ASIC figures are based on an ASIC configured to implement the algorithm. As can be seen in the table, a hardware solution is five orders of magnitude superior in both performance and energy consumption (as measured in Gb/s per Watt). For streaming encryption applications described in the previous section, pure embedded software solutions are inadequate. Hardware acceleration is used.

TABLE 1

| Platform | Throughput | | Power | Gb/s/W |
|---|---|---|---|---|
| Java | 450 | bits/s | 120 mW | 0.00042 |
| C | 345 | Kbits/s | 120 mW | 0.029 |
| 0.18 □m | 2.29 | Gb/s | 56 mW | 35.7 |
| ASIC | | | | |

In order to incorporate software and hardware acceleration and simultaneously allow for incremental refinement in the design flow process, it is advantageous to use a technique called hardware software acceleration transparency. Hardware/software acceleration transparency is described below in further detail and involves three related items: 1) incremental acceleration, 2) Java function emulation, and 3) interface transparency.

The first principle of acceleration transparency is incremental refinement acceleration. In the example shown in FIG. 26A, a Java application calls a Rijndael method. Based upon profiling results, if the performance of the pure Java solution is inadequate, it can be accelerated using a C function, as shown in FIG. 26B. Rather than designing a custom interface to the C Rijndael function, as shown in the dotted line in FIG. 26B, the application accesses the function through the Java Native Interface (JNI). If profiling and comparison with system specifications determine that hardware acceleration is used, a crypto-processor can be designed and interfaced to the Java application. However, this crypto-processor does not directly interface with the Java application (as shown in the dotted line in FIG. 26C) but is accessed via assembly instructions by a skeletal C function, which itself is accessed by the Java application via the JNI. Though it seems wasteful in terms of overhead to use these interfaces, incremental refinement allows for a smoother design flow than creating custom interfaces at each of the design levels. Methods for the design of domain-specific co-processors can be found in.

Hardware/software acceleration transparency also includes Java function emulation, a term used to describe the interface relationship between the Java application and the accelerated function. For example, a Java application wishes to access a Rijndael function via a function call rijndael( ). From the above discussion, the Java application has one of three alternatives to obtain the implementation: 1) a Java function, 2) a C function, or 3) hardware acceleration.

Hardware/software acceleration transparency means that, to the Java application, each of these alternatives is accessed with the same Java function signature. In the pure Java case, this is already apparent: A Java Rijndael function is accessed by the Java application with a simple function call rijndael( ). For C acceleration, interfaces are constructed such that the Java application can access the C Rijndael function with the same function call rijndael( ). For hardware acceleration, HW/SW interfaces to the crypto-processor are designed such that Rijndael functionality is again accessed by the same function call rijndael( ). In this way, from the Java application vantage point, each of these alternatives “looks” exactly the same. To the application, each of the three alternatives takes in the same input, produces the same output, and is accessed by the same Java function and hence functionally is the same, as seen in FIG. 26D, FIG. 26E, and FIG. 26F.

Part of the previously mentioned Java function emulation is the concept of interface transparency. This is also illustrated in FIGS. 26A-F. Interface transparency means that to the Java application, all the interfaces in between it and the acceleration implementation are transparent. In other words, the Java application can directly “see” the acceleration implementation (which looks to it like a Java function) regardless of the number of interfaces. Interface transparency essentially raises co-processor control a number of abstraction layers directly to the Java application level.

The use of hardware/software acceleration transparency, allows the designer to build interfaces incrementally. Instead of tearing down the previous interface and starting from scratch at each abstraction level, the next interface incrementally refines the previously constructed interface. Thus, the interface design flow is smooth and continuous. Acceleration transparency allows for system performance modeling at each abstraction level. As each accelerated function is placed into the overall system, the hybrid system can be re-benchmarked and the performance gains ascertained. As the system progresses from software to hardware, the original Java application needs only minor modification. Using acceleration transparency implies that each of the acceleration modules “looks” like the initial Java function in the original application; hence, the original Java application can remain the same (or relatively unchanged) from the beginning functional simulation to the final HW/SW system implementation. Once the interface hierarchy is constructed, a new acceleration module can be appended to the system through the pre-designed interfaces. A system can thus be reconfigured in a systematic way.

The following example shows HW/SW acceleration transparency and gives performance measurements for interface overhead. The simulation environment used for the example includes a cycle-true LEON-Sparc simulator. C code is compiled with the GNU C compiler gcc V3.2 with full optimization (−O2). Java byte-code is interpreted on the KVM embedded virtual machine from the Java2 Micro Edition. Thus, cycle counts for Java are cycles of the target LEON-Sparc which runs KVM that in turn runs the Java program.

The example begins with the aforementioned interface specification of the Rijndael in Java and C. A 128-bit key and 128-bit data block are used in the example.

The interfaces are as follows:

Java: int[ ] rijndael(int[ ] key, int [ ]din)

C: void rijndael(int din[4], int key[4], int dout[4])

A pure Java implementation for Rijndael on top of KVM takes 301,034 cycles, as shown in FIG. 27. All numbers in the figure are for one iteration of the Rijndael algorithm, starting from the Java function call. Startup overhead, such as setting up the C or Java runtime environments, is not included.

A first refinement to the pure Java model is to substitute the pure Java implementation with a native implementation in C. A native method in Java is shown in FIG. 26A. The corresponding C implementation is shown in FIG. 26B. A function renaming is used in order to reflect the position of the native method in the Java class hierarchy. The C implementation then can forward control to the implementation of the rijndael( ) function.

The rijndael( ) function of FIG. 26B can, at first, call an implementation of the Rijndael algorithm in C. When the NIST reference code is used, the figures as shown in the second column of FIG. 27 are obtained. There are 44,430 cycles per Rijndael call, of which 367 can be attributed to the interfacing part (FIGS. 26A and B) and the rest to native implementation. Overall a performance gain of 6.8× is seen.

The next step is to substitute the C implementation with a native hardware implementation of the Rijndael algorithm. A hardware coprocessor is used that completes a 128-bit encryption in 11 clock cycles. This hardware processor is interfaced to the co-processor interface of the Sparc, and programmed as shown in FIG. 26C. The 128-bit key and data are provided with two double-word move instructions. In this case, the resulting performance was 903 cycles. Here, the interfaces turn out to consume the major part of the cycle budget. The actual encryption takes only 11 cycles; going from Java to hardware consumes 892 cycles. The performance gain in going from Java to hardware is now 333×.

While the performance gain of moving from Java to native implementation is substantial, it is not completely overhead-free. This overhead is primarily caused by moving data across the hierarchy levels in the model. This overhead can be reduced by treating data-flow and control-flow separately. In any case, the incremental refinement of the model is a major advantage from the design-flow point-of-view.

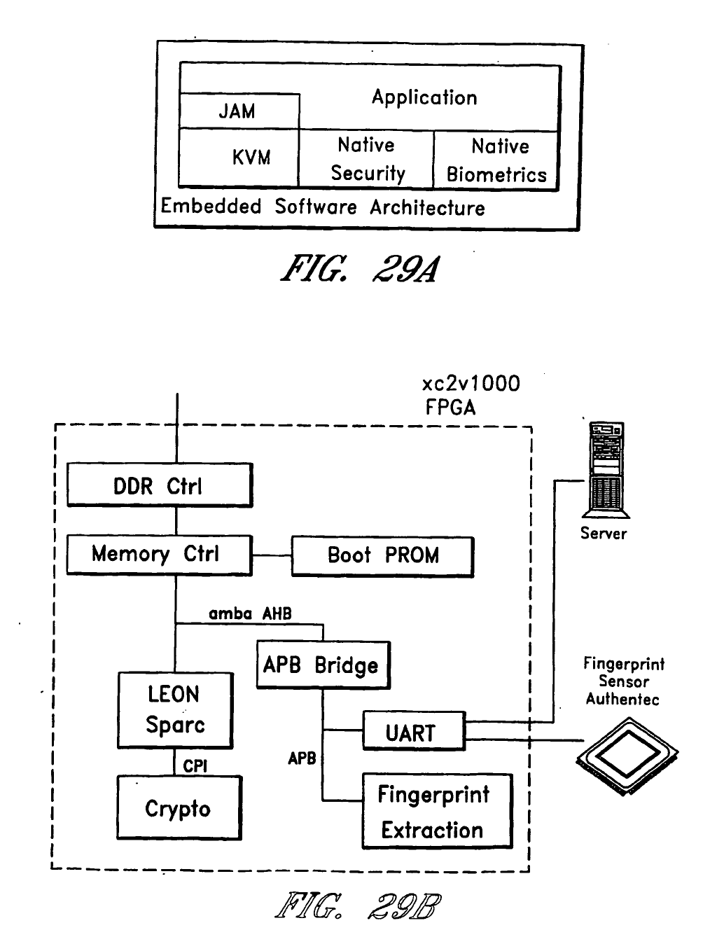

The design of the thumbpod 200 uses a number of abstraction levels, with each abstraction level based on design decisions and interface construction. The smooth transition from one model to another allows for successive refinement of the system. FIG. 28A is a block diagram showing a functional model of hardware/software accelerator design. The functional model models the thumbpod functional protocol on a PC environment (e.g., Pentium processor) in Java. As shown in FIG. 28A, this model includes an encryption function performed in Java. A C function is also used to perform fingerprint verification signal processing. A C function rather than Java is used here in order to incorporate the NIST standard fingerprint detection algorithms given in C code. This function interfaces with the application via JNI. Communication between modules (thumbpod 200, register 401, and authentication server 310) is performed in a sequential main method.

FIG. 28B is a block diagram showing a benchmarking functional model of hardware/software accelerator design. In this abstraction level in FIG. 28B the encryption function is accelerated as a C function for benchmarking purposes. An interface is constructed which allows the C encryption function to interface with the application via JNI. encryption performance measurements are compared with the functional model.

FIG. 28C is a block diagram showing a transaction-level model of hardware/software accelerator design. In this abstraction level the communication between modules is modified to allow objects to communicate with one another in a transaction level manner, instead of being controlled by a sequential main method. The transaction-level applications communicate to one another via socket programming models.

FIG. 28D is a block diagram showing an embedded software implementation model functional model of hardware/software accelerator design for a personal computer implementation. Since the goal of the project is to implement the thumbpod 200 on an embedded hardware platform, the next abstraction level is the embedded software implementation model. In this model, the thumbpod 200 application operates on KVM (an embedded virtual machine) rather than JVM, and communicates with the accelerated C functions through a customized KNI (JNI for KVM) interface, rather than a standard JNI interface. In this model the effects of the constrained embedded environment can be ascertained.

FIG. 28E is a block diagram showing an embedded software implementation model of software accelerator design for a board-level implementation. In this abstraction level, the thumbpod 200 application is moved entirely onto an embedded hardware platform. In one embodiment, the application runs on top of KVM operating on a C backbone on a LEON 32-b Sparc processor (FPGA). The acceleration continues to be performed in C. The FPGA board communicates with the PC via a UART and Java server proxy.

FIG. 28F is a block diagram showing an embedded software implementation model of hardware/software accelerator design for a board-level implementation. In this abstraction level, hardware acceleration is introduced both for biometric signal processing and for encryption. The hardware co-processors (implemented within an FPGA) interface with the Java application via a C interface and KNI. This abstraction level demonstrates the applicability and performance of HW/SW acceleration transparency.

FIG. 29 shows one embodiment of a thumbpod architecture. The software architecture is built upon an embedded Java virtual machine (KVM) which has been extended with appropriate platform specialization. The KVM executes on top of a LEON Sparc processor, which in turn is configured as a soft-core in a Virtex XC2V1000 FPGA. The system has three levels of configuration: Java, C, and hardware. The prototyping environment is an Insight Electronics development board, which contains besides the FPGA also a 32 MByte DDR RAM.

The LEON/Sparc core provides two interfaces: a high-speed AMBA bus interface (AHB) and a co-processor interface (CPI). Each interface has specific advantages toward domain-specific co-processors. The CPI offers an instruction- and register-set that is visible from within the Sparc instruction set, and allows a close integration of a domain-specific processor and the Sparc. The AMBA bus uses mapping of a co-processor through the abstraction of a memory interface. The CPI provides two 64-bit data ports and a 10-bit opcode port.

The high speed AMBA bus contains a memory interface and a bridge to the peripheral bus interface (APB). The memory interface includes an interface to a 32 MByte DDR RAM memory. The AMBA peripheral bus (APB) contains the fingerprint processor and two UART blocks. One connection is used to attach a fingerprint sensor 202, while the second one is used to connect an application server. This server is used to download and debug applications, as well as to experiment with the security protocol.

Although the preceding description contains much specificity, this should not be construed as limiting the scope of the invention, but as merely providing illustrations of embodiments thereof. Many other variations are possible within the scope of the present invention. For example, one of ordinary skill in the art will recognize that the thumbpod can be implemented using a variety of virtual machine and/or operating environments, such as, for example, Windows CE, TinyOS, PALM OS, Linux. etc. Although JAVA is described as being used in one or more embodiments, other languages can be used as well, such as, for example, high-level languages, low-level languages, C/C++, lisp, assembly language, etc. Thus, the scope of the invention is limited only by the claims.

What is claimed is:

1. A secure system for biometric signal processing, comprising:
a secure communication protocol configured to localize biometric data, wherein said protocol provides authentication without transmission of said biometric data; and
a key generation function based on a dynamic key generator and static biometric components.

2. A secure system for biometric signal processing, comprising:
a fingerprint image sensor;
a cryptographic module configured to encrypt and decrypt data using a secret key known to said cryptographic hardware accelerator and to an authentication server; and
a communication protocol module configured to receive an authentication vector from said authentication server, verify an identity of said authentication server, and to provide authentication of a user to said authentication server without transmission of biometric data.

3. The system of claim 2, further comprising a communication port.

4. The system of claim 2, wherein a biometric verification process is performed within the secure system.

5. The system of claim 2, wherein a fingerprint verification process is performed within the secure system using minutia detection and matching algorithms.

6. The system of claim 2, wherein access to said cryptographic hardware accelerator is substantially transparent to a JAVA program.

7. A method for providing secure communications, comprising
sending an identification code to a transaction terminal;
forwarding said identification code and transaction data from said transaction terminal to an authentication server;
generating a first authorization vector;
encrypting at least a portion of said first authorization vector using a first secret key to produce a first encrypted authorization vector;
sending said first encrypted authorization vector to said transaction terminal;
forwarding said first encrypted authorization vector from said transaction terminal to a biometric identification device comprising a biometric identification sensor;
decrypting said first encrypted authorization vector to create a first decrypted authorization vector;
verifying an identity of said authorization server using at least portion of said first decrypted authorization vector;
sensing biometric data using said biometric identification sensor;
examining said biometric data to verify an identity of a user of said biometric identification device;
generating a second authorization vector;
encrypting at least a portion of said second authorization vector using a second secret key to produce a second encrypted authorization vector;
sending said second encrypted authorization vector to said transaction terminal;
forwarding said first encrypted authorization vector from said transaction terminal to said authentication server;
decrypting said first encrypted authorization vector to create a second decrypted authorization vector; and
verifying an identity of said user using at least a portion of said second decrypted authorization vector.

8. The method of claim 7, further comprising:
profiling a JAVA application module of said biometric identification device;
converting relatively moderately-used portions of said JAVA application to a C language portion and accessing said C language portion without substantially modifying said JAVA application module; and
converting relatively heavily-used portions of said JAVA application into hardware and accessing said hardware through an interface without substantially modifying said JAVA application module.

9. The method of claim 7, wherein said first secret key and said second secret key are substantially identical.

10. The method of claim 7, wherein said sending an identification code comprises wireless transmission.

11. The method of claim 7, wherein said sending an identification code comprises infrared transmission.

12. The method of claim 7, wherein said sending an identification code comprises radio-frequency wireless transmission.

13. The method of claim 7, wherein said encrypting said at least a portion of said first authorization vector comprises a Rijndael algorithm.

14. The method of claim 7, wherein said biometric sensor comprises a fingerprint sensor.

15. The method of claim 7, wherein said biometric sensor comprises an RFID sensor.

16. The method of claim 7, wherein said biometric sensor comprises a retina scan sensor.

17. The method of claim 7, wherein said biometric data comprises image data.

18. The method of claim 7, wherein said biometric data comprises fingerprint image data.

19. The method of claim 7, wherein said verifying an identity of said user comprises identifying minutiae in a fingerprint scan.
